(19) United States
(12) Patent Application Publication
(10) Pub. No.: US 2022/0405663 A1
(43) Pub. Date: Dec. 22, 2022

(54) PREDICTIVE RISK MANAGEMENT FOR DYNAMIC TREE TRIMMING SCHEDULING FOR DISTRIBUTION NETWORKS

(71) Applicant: The Texas A&M University System, College Station, TX (US)

(72) Inventors: Mladen Kezunovic, College Station, TX (US); Tatjana Dokic, College Station, TX (US); Zoran Obradovic, College Station, TX (US)

(73) Assignee: The Texas A&M University System, College Station, TX (US)

(21) Appl. No.: 17/842,244

(22) Filed: Jun. 16, 2022

Related U.S. Application Data
(60) Provisional application No. 63/211,208, filed on Jun. 16, 2021.

(51) Int. Cl. G06Q 10/06

(52) U.S. Cl. CPC G06Q 10/06311

(57) ABSTRACT

A system for generating a dynamic tree trimming schedule, comprising a network vegetation model system operating on a first processor and configured to receive a network vegetation model and weather forecast data and to generate a real-time tree trimming schedule as a function of the network vegetation model and weather forecast data and a remote user interface operating on a second processor and configured to receive the real-time tree trimming schedule and to generate one or more user interface controls as a function of the real-time tree trimming schedule.

### RELATED APPLICATIONS

The present application claims benefit of and priority to U.S. Provisional patent application 63/211,208, filed Jun. 16, 2021, which is hereby incorporated by reference as if set forth herein in its entirety.

### GOVERNMENT FUNDING

This invention was made with U.S. Government support under grant number NSF1636772, awarded by the National Science Foundation. The Government has certain rights in this invention.

### TECHNICAL FIELD

The present disclosure relates generally to distribution feeder vegetation management, and more specifically to distribution feeder vegetation management based on a risk framework.

### BACKGROUND OF THE INVENTION

Power outages caused by vegetation result in substantial costs, but it is difficult to perform trimming of vegetation in a cost-effective manner.

### SUMMARY OF THE INVENTION

A system for generating a dynamic tree trimming schedule is disclosed that includes a network vegetation model system that receives a network vegetation model and weather forecast data and that generates a real-time tree trimming schedule as a function of the network vegetation model and weather forecast data. A remote user interface is configured to receive the real-time tree trimming schedule and to generate one or more user interface controls as a function of the real-time tree trimming schedule, such as to notify an operator that an update has been received to allow the operator relocate tree trimming activities as a function of weather conditions.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE SEVERAL VIEWS OF THE DRAWINGS

Aspects of the disclosure can be better understood with reference to the following drawings. The components in the drawings may be to scale, but emphasis is placed upon clearly illustrating the principles of the present disclosure. Moreover, in the drawings, like reference numerals designate corresponding parts throughout the several views, and in which:

FIG. 1 is a diagram of a system implementing an algorithm for weather data processing, in accordance with an example embodiment of the present disclosure;

FIG. 2 is a diagram of a system implementing an algorithm for vegetation data processing, in accordance with an example embodiment of the present disclosure;

FIG. 3 is a diagram of a system implementing an algorithm for utility data processing, in accordance with an example embodiment of the present disclosure;

FIG. 4 is a diagram of a system implementing an algorithm for generating a temporal correlation, in accordance with an example embodiment of the present disclosure;

FIG. 5 is a diagram of a system implementing an algorithm for real-time data processing, in accordance with an example embodiment of the present disclosure;

FIG. 6 is a diagram of a system for extracting power line and distribution pole data for use with the disclosed risk management system and method, in accordance with an example embodiment of the present disclosure;

FIG. 7 is a diagram of a system for graphing power line and distribution pole data for use with the disclosed risk management system and method, in accordance with an example embodiment of the present disclosure;

FIG. 8 is a diagram of a system for generating historical outage data for use with the disclosed risk management system and method, in accordance with an example embodiment of the present disclosure;

FIG. 9 is a diagram of a system for generating tree trimming data for use with the disclosed risk management system and method, in accordance with an example embodiment of the present disclosure;

FIG. 10 is a diagram of a system for adding historical data with no outages for use with the disclosed risk management system and method, in accordance with an example embodiment of the present disclosure;

FIG. 11 is a diagram of a system for creating graph buffers for use with the disclosed risk management system and method, in accordance with an example embodiment of the present disclosure;

FIG. 12 is a diagram of a system for temporal correlation of historical land-based weather measurements for use with the disclosed risk management system and method, in accordance with an example embodiment of the present disclosure;

FIG. 13 is a diagram of a system for spatial correlation of historical land-based weather measurements for use with the disclosed risk management system and method, in accordance with an example embodiment of the present disclosure;

FIG. 14 is a diagram of a system for averaging of historical land-based weather measurements for use with the disclosed risk management system and method, in accordance with an example embodiment of the present disclosure;

FIGS. 15A and 15B are a diagram of a system for vegetation classification survey data processing for use with the disclosed risk management system and method, in accordance with an example embodiment of the present disclosure;

FIG. 16 is a diagram of a system for weather forecast processing for use with the disclosed risk management system and method, in accordance with an example embodiment of the present disclosure;

FIG. 17 is a diagram of a system for imagery data processing for use with the disclosed risk management system and method, in accordance with an example embodiment of the present disclosure; and

FIGS. 18A and 18B are a diagram of a system for use with the disclosed risk management system and method, in accordance with an example embodiment of the present disclosure.

### DETAILED DESCRIPTION OF THE INVENTION

In the description that follows, like parts are marked throughout the specification and drawings with the same reference numerals. The drawing figures may be to scale and certain components can be shown in generalized or schematic form and identified by commercial designations in the interest of clarity and conciseness.

The present disclosure relates to a software tool for vegetation management in an electric distribution network based on predictive risk analysis. A variety of input data are preprocessed to extract parameters of interest and to spatially and temporally correlate all the data. Then risk is calculated based on a prediction algorithm trained with historical input data. The calculated risk and economic impacts are used to develop a cost-effective tree trimming schedule based on minimization of risk.

The present disclosure provides the capability to predict risk of vegetation-caused outages in a distribution network based on real-time network and environmental data. The capability to dynamically generate optimal tree trimming schedules based on predictive risk analysis is also provided.

Electric utilities can use the present disclosure to observe risk of vegetation related outages in real-time, and then develop optimal action strategies for mitigation of vegetation related outages by trimming trees on the feeders with the highest risk.

The present disclosure provides a predictive method for distribution feeder vegetation management based on a risk framework. The state of risk is calculated for each feeder section using a variety of factors extracted from network parameters and historical outage data, historical weather data and weather forecasts, and a variety of vegetation indices. A framework is provided that implements a spatiotemporal correlation of the collected data. In one example embodiment, a Gaussian Conditional Random Field (GCRF) prediction model can be used. Based on the calculated risk, the dynamic optimal tree trimming schedule, which minimizes the overall risk for the system under a given predetermined budget, is developed.

The present disclosure provides a number of technical innovations:

1) A variety of data sources including historical weather and weather forecast data, vegetation indices and high resolution imagery data, historical utility records about outages and maintenance and other data sources as discussed and described herein are used to improve tree trimming scheduling. The integration and correlation of these disclosed data sources is novel.

2) The disclosed spatiotemporal model can be used to correlate a variety of data in time and space and provides real-time generation of predictive risk maps for assessment of the vegetation around the distribution feeders.

3) An analytical approach is disclosed for vegetation risk management based on GCRF or other suitable algorithms, which takes into account both the spatial and the temporal configuration of the network and past events to improve the prediction performances.

4) An optimized, cost-effective dynamic tree trimming scheduler is disclosed that is adapted to minimize the overall risk of the network while maintaining the economic investment in periodic tree trimming. The unique benefits of this approach are demonstrated on an actual utility distribution network.

Weather and vegetation impacts vegetation-caused outages, as do vegetation management practices implemented by the utilities. There are two major classes of vegetation-related feeder outages in distribution systems, which are differentiated by the tree coming in contact with feeders due to 1) overgrowing the feeder height, and 2) being forced into a contact with the feeder due to wind or some other similar weather impacts.

Data processing is used to convert raw data into processed inputs for the predictive risk analysis and optimal tree trimming scheduler, such as by spatiotemporal correlation, spatial processing of the data using the ArcGIS mapping software available from ESRI of Redlands, Calif. or other suitable software. Temporal data processing can be performed using various Python libraries or other suitable software.

Raw data are processed to remove unused components. All the data that has a geographical reference can be placed into a geodatabase during the preprocessing. Parameters that can be used for the prediction model, and the associated temporal and spatial references, include but are not limited to (polylines and polygons can be used interchangeably where suitable and are not intended to be limiting in these example embodiments):

| | Historical | Periodic | Reactive | | | | |
|---|---|---|---|---|---|---|---|
| | Outage | Tree | Tree | | | | |
| | Data | Trimming | Trimming | Poles | Lines | Vegetation | Weather |
| Spatial | Point | Polyline | Polyline | Point | Polyline | Raster or | Points or |
| | shapefile | shapefile | shapefile | shapefile or | shapefile or | Polygon | Polygon |
| | or any | or any | or any | any other | any other | shapefile | shapefile or |
| | other | other | other | suitable | suitable | or any | any other |
| | suitable | suitable | suitable | format | format | other | suitable |
| | format | format | format | | | suitable | format |
| | | | | | | format | |
| Temporal | Start and | Year | Date | In service/Out | In | Year | 1 min to 3 |
| | end | quarter | | of service | service/Out | | hours |
| | time | | | dates | of service | | |
| | | | | | dates | | |
| Other | Num. of | Trim | Cost, etc. | Material/class | Conductor | Imagery | Wind (speed, |
| parameters | customers | period | | Height, etc. | size | Vegetation | gust, |
| | Cause | Num. of | | | Conductor | classes, | direction) |
| | code, | customers | | | count | etc. | Temperature |
| | etc. | Cost, etc. | | | Conductor | | Precipitation |
| | | | | | material | | Humidity |
| | | | | | Nominal | | Pressure |
| | | | | | voltage, | | Forecast |
| | | | | | etc. | | indices, etc. |

Data can be provided with different spatial and temporal resolutions. For example, historical weather data from Automated Surface Observing System (ASOS) land stations can be obtained with temporal resolution of up to 1 min, but the spatial resolution of that data may be low, including only a few weather stations in the network service area. Any other suitable source of weather station data can be used. Vegetation data can have a low temporal resolution, such as when it is collected once per year or two years, but can have a high spatial resolution, such as up to 50 cm. The rate of data collection can vary not only between different data sets, but also within a single data set. For example, weather data can be collected by land-based weather stations with a maximum rate of one data point per minute, but the rate can go down to one data point per hour at times. In some rare cases, the rate may go as low as one point within several hours. After this initial preprocessing, the dataset may still not be ready for the input into the predictive risk model until predetermined parameters are spatially and temporally correlated.

Image data can be used to extract the location of vegetation surrounding the network. Imagery can be collected from a suitable source, such as the Texas Natural Resources Information System (TNRIS) database, the National Agriculture Imagery Program 1 m NC\CIR database, the Texas Orthoimagery Program 50 cm NC\CIR database or any other suitable imagery database.

The datasets can be loaded into the geodatabase as raster files or in other suitable manners. To reduce the amount of data for processing, imagery raster files can be clipped to a 20 m buffer around the distribution lines. Any unsupervised or supervised image classification or other suitable processes can be applied on the imagery dataset to classify between areas covered in vegetation (“vegetation class”) and all other areas (“non-vegetation class”). The vegetation class can then be transferred to the next step (spatial correlation), and any unused or unneeded data can be discarded.

The result of image processing is a set of historical maps with vegetation locations. These maps can then be spatially joined with other data, such as the Ecological Mapping System of Texas (EMST) developed by the Texas Parks and Wildlife Department, which contains the classification by vegetation type into 398 distinct classes, or any other suitable ecological classification by vegetation type, to identify classes that are present at the network location of interest. The average canopy height for the vegetation classes in the network area can then be added to the vegetation dataset as a parameter.

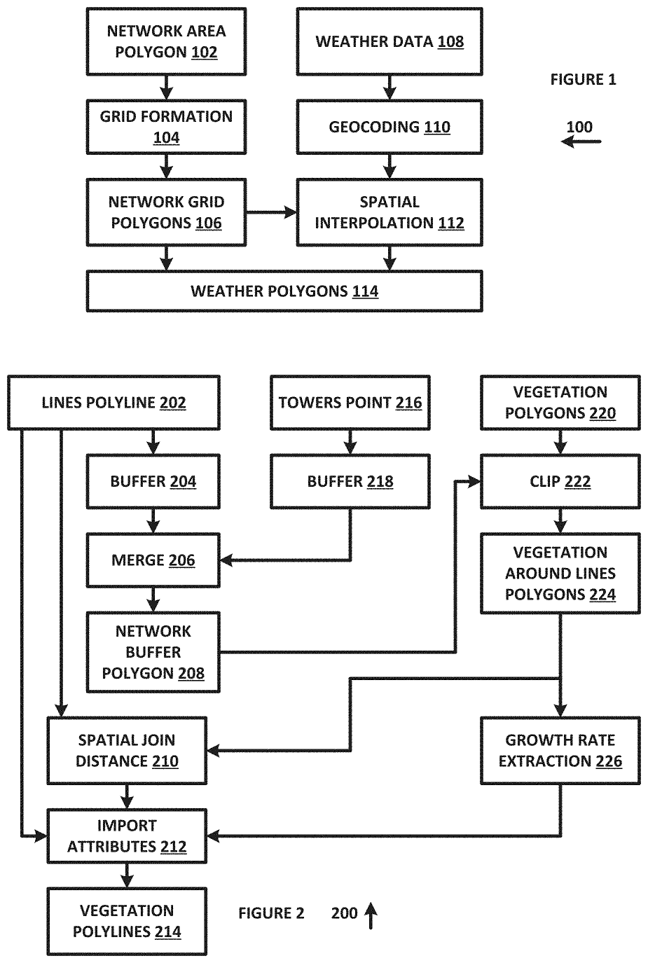

A spatial correlation module can be used to provide spatial links between different data sets. For example, for every historical outage, the weather conditions at that specific location, the distance between the line and the closest tree, the location of areas that were trimmed and other data can be correlated. Spatial correlation can be implemented as shown in FIGS. 1 to 3.

FIG. 1 is a diagram of a system 100 implementing an algorithm for weather data processing, in accordance with an example embodiment of the present disclosure. The system can be implemented as one or more discrete hardware components or one or more software components operating in conjunction with a processor or processors that generates data processing structures and user interface controls, as discussed and described herein.

System 100 can be used to create a weather data grid that is overlaid on the utility network and that has a suitable spatial resolution, such as 1 km. The weather parameters in each grid cell can be calculated from the weather station values using linear interpolation.

Network area polygon 102 is a dataset defining a utility network area, such as map coordinate data, geolocation data or other suitable data, and which contains a plurality of polygons that can have fixed or variable attributes that are used to correlate the utility network area with areas from other data sets, such as weather data sets, vegetation data sets and so forth. In one example embodiment, network area polygon 102 can generate a database of polygons that each have associated geolocation coordinate data and a predetermined shape and orientation, so that the relationship of each polygon to every other polygon can be determined. Each polygon can have associated identification data that can be used to correlate the polygon to other data sets.

Grid formation 104 can be implemented as one or more algorithms operating on a processor that receive data defining network area polygons and can generate a grid that correlates to the network area polygons. In one example embodiment, the grid can have predetermined dimensions, such as one kilometer squares or other suitable shapes and sizes, such as to create grid formation polygons or other suitable data structures.

Network grid polygons 106 is a dataset defining network area as a set of polygons, the grid formation or other suitable data and can generate correlated data that includes network area polygon data, grid data and other suitable data.

Weather data 108 is a dataset containing information about weather activity in a geographic location. In one example embodiment the weather data can include weather associated with a geographic location such as a series of map coordinates, one or more specified data fields, can contain one or more predetermined data fields, such as temperature data as a function of location and time, humidity data as a function of location and time, atmospheric pressure data as a function of location and time, wind characteristics as a function of location and time, precipitation as a function of location and time and other suitable weather data, or data for other suitable attributes.

Geocoding 110 can be implemented as one or more algorithms operating on a processor that receive data defining weather activity associated with weather station locations and which generates geocoding data associated with the weather activity associated with weather station location. In one example embodiment, the geocoding can identify addresses or other suitable data and can convert the addresses into geographic coordinates, such as a latitude and longitude, a range of latitudes and longitudes and other suitable data.

Spatial interpolation 112 can be implemented as one or more algorithms operating on a processor that receive data defining network grid polygons, geolocated weather data and other suitable data, can interpolate the data to correlate with the network grid polygons and other suitable data. In one example embodiment, weather data may be associated with geolocation coordinates, where a large number of network grid polygons fall between the geolocation coordinates. Spatial interpolation 112 can interpolate the weather data and assign interpolated values to each network grid polygon and can perform other suitable functions.

Weather polygons 114 is a set of datasets containing one weather polygon dataset for each moment in time. It is formatted as network grid polygons that have as attributes values calculated based on spatial interpolation of weather data. It generates weather polygons having predetermined spatial and temporal resolution for temperature, humidity, pressure wind characteristics, precipitation and other suitable weather data.

In operation, system 100 can be used to create a weather data grid that is overlaid on the utility network and that has a suitable spatial resolution. Although system 100 is shown as a process, a person of skill in the art will recognize that it can also or alternatively be implemented as a state diagram, an object oriented diagram, a ladder chart, in other suitable programming paradigms or in a suitable combination of such programming paradigms.

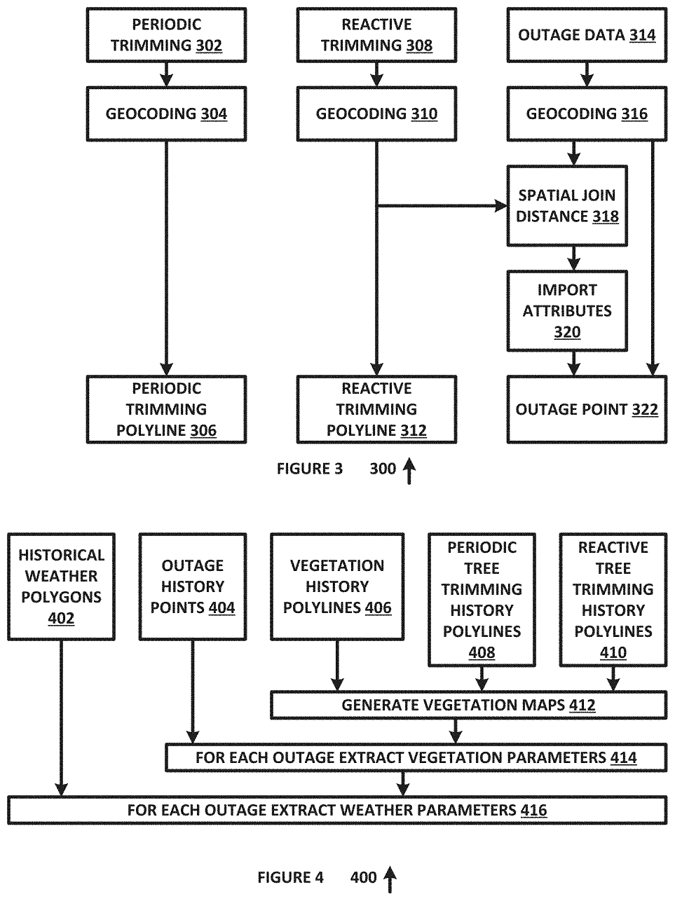

FIG. 2 is a diagram of a system 200 implementing an algorithm for vegetation data processing, in accordance with an example embodiment of the present disclosure. The system can be implemented as one or more discrete hardware components or one or more software components operating in conjunction with a processor or processors that generates data processing structures and user interface controls, as discussed and described herein.

Vegetation data processing extracts the vegetation indices, such as distance between the lines and vegetation and growth rate, using spatial links between multiple preprocessed vegetation files. The calculated parameters are stored as attributes in the final vegetation polyline shapefile or any other suitable format.

Lines polyline 202 is a dataset defining lines in the electric power grid, including elevated and underground power lines, distribution feeders, and so forth, and generates polylines with associated power line and grid information data. In one example embodiment, the polylines can have predetermined parameters such as size and location data, and can be correlated with towers points, vegetation polygons, weather polygons or other suitable data.

Buffer 204 can be implemented as one or more algorithms operating on a processor that receive data from lines polyline 202 and creates a reclassification based on the distance. The buffer creates a polygon around the object that contains the area that is within a specified distance.

Merge 206 can be implemented as one or more algorithms operating on a processor that receive data defining lines polygons and towers polygons and which generated merged network polygon data. In one example embodiment, the merged network polygon data can include interpolated data and other suitable data processing to conform the lines polygons data and the towers polygons data.

Network buffer polygon 208 is a dataset created by merge 206 of the two buffers around lines and towers (204 and 218).

Spatial join distance 210 can be implemented as one or more algorithms operating on a processor that receive data from lines polyline 202 and vegetation around lines polygons and which perform processing on the data to spatially join the lines polyline data to correlate with vegetation around lines polygons data based on the distance between two datasets. Main product of the spatial join distance is an exact distance between each line segment and surrounding vegetation measured at the point where vegetation is closest to the line segment.

Import attributes 212 can be implemented as one or more algorithms operating on a processor that receive data (in form of attributes) spatial join distance 210 and growth rate extraction 226 and adds this data to the lines polyline dataset 202. In one example embodiment, temporal attributes for different data sets can have different time scales, varying from minutes to years, which are correlated by import attributes 212 or other suitable systems or processes. Import attributes 212 can generate modified vegetation data that has been adjusted for growth rates and other suitable data.

Vegetation polylines 214 is a dataset created as a final product of the vegetation data processing. This dataset contains all the vegetation related information overlaid on the network polygon, defining power lines, towers, vegetation and other suitable data, and which processes the data to define vegetation polygons that are able to be correlated to lines polylines, towers polygons, weather polygons and other suitable data. In one example embodiment, data output by vegetation polylines 214 can be used to identify areas where periodic vegetation trimming should be performed to minimize outage risk.

Towers point 216 is a dataset defining the location of towers in an electric power grid, such as towers for transmission and distribution facilities. In one example embodiment, the tower points can have predetermined parameters such as size and location data, and can be correlated with lines polygons, vegetation polygons, weather polygons or other suitable data.

Buffer 218 can be implemented as one or more algorithms operating on a processor that receive data from towers point 216 and creates a reclassification based on the distance. The buffer creates a polygon around the object that contains the area that is within a specified distance.

Vegetation polygons 220 is a dataset identifying vegetation found in an area and which contains vegetation polygons that can be correlated with lines polygons, towers polygons, weather polygons and other suitable data.

Clip 222 can be implemented as one or more algorithms operating on a processor that receive data from vegetation polygons 220 and network buffer polygon 208 and that clips the vegetation polygons 220 to the area of network buffer polygon 208 In one example embodiment, the data from vegetation polygons 220 that is outside of network buffer polygon 208 can be deleted to reduce data processing requirements.

Vegetation around lines 224 is a dataset containing resulting vegetation polygon after clip 222. This dataset contains locations of vegetation inside the buffer around the lines, and generates data for analysis to identify vegetation areas where increased periodic trimming could help to reduce the risk of an outage, where trimming due to weather-related issues is recommended or other suitable data.

Growth rate extraction 226 can be implemented as one or more algorithms operating on a processor that receive data identifying changes in vegetation over time and which generates predicted estimates of changes in vegetation in the area of power lines. In one example embodiment, image data of vegetation can be generated once yearly or at other sparse intervals, and the image data can be processed in combination with data identifying periodic trimming, reactive trimming or other suitable data to identify growth rates that can be a factor in a decision of whether to increase periodic trimming, to perform reactive trimming or other suitable functions.

In operation, system 200 can be used for vegetation data processing. Although system 200 is shown as a process, a person of skill in the art will recognize that it can also or alternatively be implemented as a state diagram, an object oriented diagram, a ladder chart, in other suitable programming paradigms or in a suitable combination of such programming paradigms.

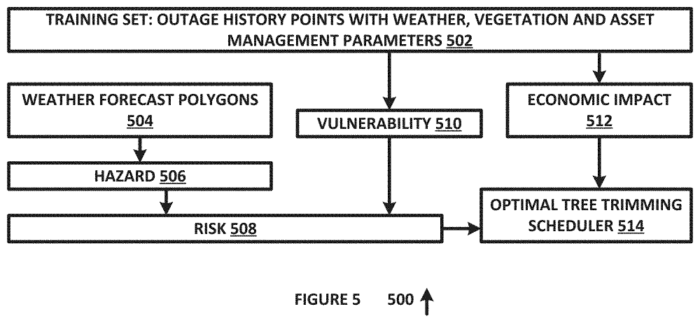

FIG. 3 is a diagram of a system 300 implementing an algorithm for utility data processing, in accordance with an example embodiment of the present disclosure. The system can be implemented as one or more discrete hardware components or one or more software components operating in conjunction with a processor or processors that generates data processing structures and user interface controls, as discussed and described herein.

Utility data processing can be used to convert the historical tables to the shapefile or any other suitable formats identifying the locations of points and polylines based on the line section codes and/or addresses provided in the utility's data files, which can be in comma separated value (CSV) format or other suitable formats. Reactive tree trimming action can also be correlated with an outage that lead to it.

To deal with different spatial resolutions of data, multiple approaches represented by systems 100, 200 and 300 or other suitable approaches can be used. Spatial interpolation can be used to extract weather data for every location in the network based on the original weather station data with sparse locations. In other instances, data can be projected to a nearby location using a spatial join. In one example embodiment, a distance between a line and vegetation can be projected to the line using a spatial join based on distance.

Periodic trimming 302 is a dataset that identifies periodic trimming zones and which processes the data for geocoding. In one example embodiment, the data can be received in a comma stored value format and can be converted to a format suitable for geocoding, or other suitable processes can also or alternatively be performed.

Geocoding 304 can be implemented as one or more algorithms operating on a processor that receive data from periodic trimming 302 and which performs geocoding on the data to allow it to be located in network polygons or correlated with other suitable data. In one example embodiment, geocoding 304 can interpolate periodic trimming data or perform other suitable functions.

Periodic trimming polyline 306 is a dataset that receive data from geocoding 304 and which contains periodic trimming polyline data that can be correlated to other suitable data.

Reactive trimming 308 is a dataset that identifies reactive trimming zones and which processes the data for geocoding. In one example embodiment, the data can be received in a comma stored value format and can be converted to a format suitable for geocoding, or other suitable processes can also or alternatively be performed.

Geocoding 310 can be implemented as one or more algorithms operating on a processor that receive data from reactive trimming 308 and which performs geocoding on the data to allow it to be located in network polygons or correlated with other suitable data. In one example embodiment, geocoding 310 can interpolate reactive trimming data or perform other suitable functions.

Reactive trimming polyline 312 is a dataset that receive data from geocoding 310 and which contains reactive trimming polyline data that can be correlated to other suitable data.

Outage data 314 is a dataset that identifies outages and which processes the data for geocoding. In one example embodiment, the data can be received in a comma stored value format and can be converted to a format suitable for geocoding, or other suitable processes can also or alternatively be performed.

Geocoding 316 can be implemented as one or more algorithms operating on a processor that receive data from outage data 314 and which performs geocoding on the data to allow it to be located in network polygons or correlated with other suitable data. In one example embodiment, geocoding 316 can interpolate outage data or perform other suitable functions.

Spatial join distance 318 can be implemented as one or more algorithms operating on a processor that receive data from geocoding 310 and geocoding 316 and that performs data processing to join two datasets created as result of geocoding 310 and geocoding 316 into a single data structure based on the distance between them. In one example embodiment, spatial join distance 318 can calculate distance between datasets created by geocoding 310 and geocoding 316, or a distance between outages and reactive tree trimming performed after the outage occurrence, or can perform other suitable processing.

Import attributes 320 can be implemented as one or more algorithms operating on a processor that receive data attributes associated with reactive trimming and outage data and which generates output data for identifying geocoded locations where periodic trimming should be performed. Import attributes 320 imports the distance between the outage and reactive trimming into the outage point dataset.

Outage point 322 is a dataset that receive data from import attributes 320 and geocoding 316 which generates outage point data to identify areas where outages have previously occurred and where increased periodic trimming can be performed to reduce failure risk.

In operation, system 300 can be used for utility data processing. Although system 300 is shown as a process, a person of skill in the art will recognize that it can also or alternatively be implemented as a state diagram, an object oriented diagram, a ladder chart, in other suitable programming paradigms or in a suitable combination of such programming paradigms.

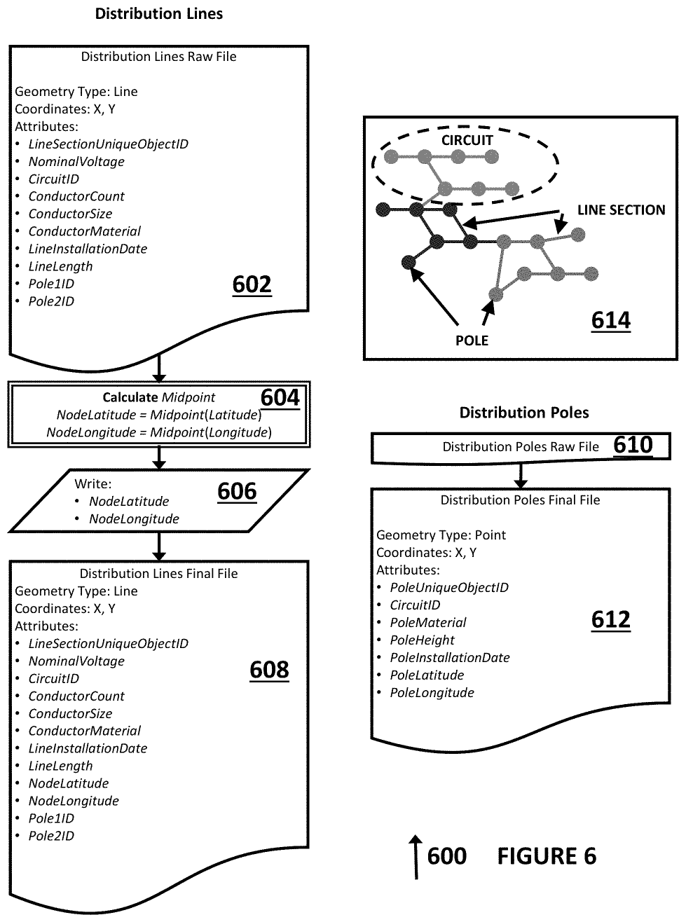

FIG. 4 is a diagram of a system 400 implementing an algorithm for generating a temporal correlation, in accordance with an example embodiment of the present disclosure. The system can be implemented as one or more discrete hardware components or one or more software components operating in conjunction with a processor or processors that generates data processing structures and user interface controls, as discussed and described herein. A temporal correlation module can use a suitable number of historical input datasets, such as weather, vegetation, outage, periodic tree trimming, and reactive tree trimming, and any other relevant datasets, to create a training set.

Historical weather polygons 402 is a database that identifies weather as a function of location and time. In one example embodiment, historical weather polygons 402 can have variable time parameters such as different measurement periods, and can be interpolated to create a common time period for subsequent data correlation or other suitable processes. Historical weather polygons 402 dataset is Weather polygons 114.

Outage history points 404 is a dataset that identifies prior outages as a function of location and time. In one example embodiment, outage history points 404 can have variable time parameters such as different measurement time zones, and can be interpolated to create a common time period for subsequent data correlation or other suitable processes. Outage history points 404 is Outage point 322.

Vegetation history polylines 406 is a dataset that identifies vegetation as a function of location and time. In one example embodiment, vegetation history polylines 406 can have variable time parameters such as different measurement time zones, and can be interpolated to create a common time period for subsequent data correlation or other suitable processes. Vegetation history polylines 406 is Vegetation polylines 214.

Periodic tree trimming history polylines 408 is a dataset that identifies periodic tree trimming as a function of location and time. In one example embodiment, periodic tree trimming history polylines 408 can have variable time parameters such as different measurement time zones, and can be interpolated to create a common time period for subsequent data correlation or other suitable processes. Periodic tree trimming history polylines 408 is Periodic trimming polyline 306.

Reactive tree trimming history polylines 410 is a dataset that identifies reactive tree trimming as a function of location and time. In one example embodiment, reactive tree trimming history polylines 410 can have variable time parameters such as different measurement time zones, and can be interpolated to create a common time period for subsequent data correlation or other suitable processes. Reactive tree trimming history polylines 410 is Reactive trimming polyline 312

Generate vegetative maps 412 can be implemented as one or more algorithms operating on a processor that receive data from vegetation history polylines 406, periodic tree trimming history polylines 408 and reactive tree trimming history polylines 410 and which generate vegetation maps for identifying trimming areas. In one example embodiment, generate vegetative maps 412 can correlate data to generate vegetative maps for identifying tree trimming recommendations. Generate Vegetation Maps processes input dataset to create temporal distribution of vegetation coverage. For each time instance of interest Generate Vegetation Maps process will combine knowledge from all three datasets, vegetation history polylines 406, periodic tree trimming history polylines 408 and reactive tree trimming history polylines 410, to provide estimate of state of vegetation around the lines.

For each outage extract vegetative parameters 414 can be implemented as one or more algorithms operating on a processor that receive data identifying outages and which extracts vegetative parameters that are present in the system during the time of the outage and at the location of the outage. In one example embodiment, the vegetation parameters for each outage can include an identification of whether vegetation was closer to a power line or other power system facility than recommended, or other suitable data.

For each outage extract weather parameters 416 can be implemented as one or more algorithms operating on a processor that receive data identifying outages and which extracts weather parameters that are present in the system during the time of the outage and at the location of the outage. In one example embodiment, the weather parameters for each outage can include an identification of whether severe weather conditions were close to a power line or other power system facility, or other suitable data.

In operation, system 400 can be used to generate a temporal correlation. Although system 400 is shown as a process, a person of skill in the art will recognize that it can also or alternatively be implemented as a state diagram, an object oriented diagram, a ladder chart, in other suitable programming paradigms or in a suitable combination of such programming paradigms. The final result of the system 400 is Training set 502 that is used as input in the real-time processor.

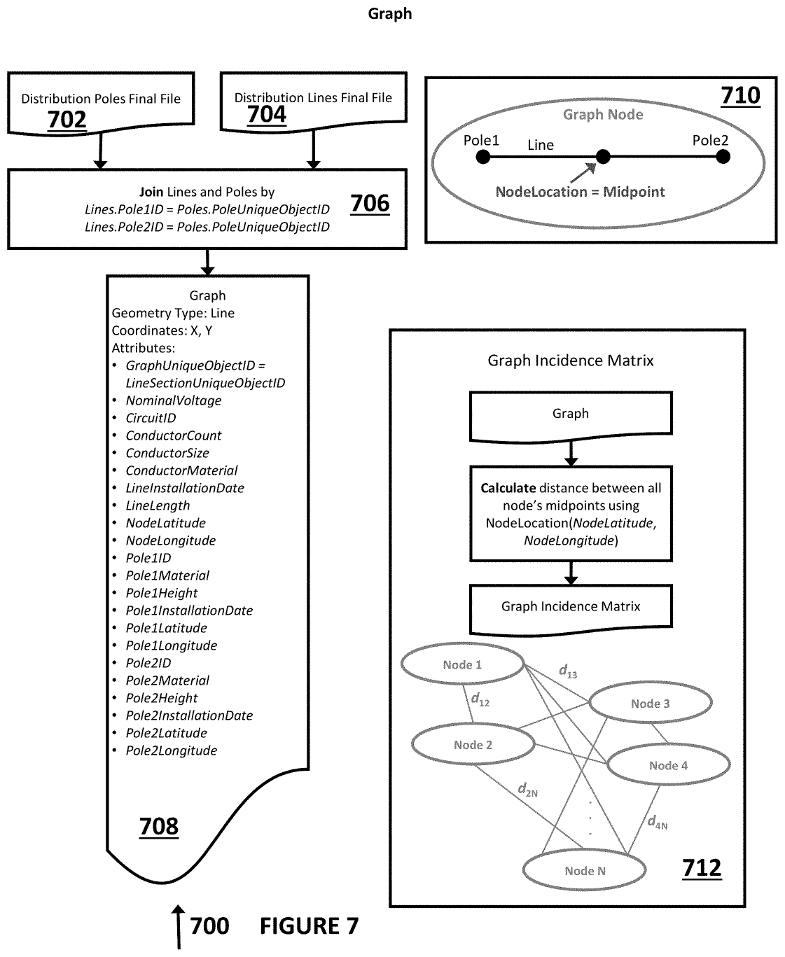

FIG. 5 is a diagram of system 500 implementing an algorithm for real-time data processing, in accordance with an example embodiment of the present disclosure. The system can be implemented as one or more discrete hardware components or one or more software components operating in conjunction with a processor or processors that generates data processing structures and user interface controls, as discussed and described herein.

The training set can be used with real-time weather forecast input to generate an optimal tree trimming schedule. Each dataset can contain a variety of parameters (attributes), and is stored as a GIS shapefile or any other suitable format.

Training set 502 can be implemented as one or more algorithms operating on a processor that receive data that defines outage history points with weather, vegetation and asset management parameters and which generates training data sets that can be used for training of the machine learning algorithm, for example GCRF or other suitable processes. In one example embodiment, training set 502 can generate outputs for determining vulnerability, economic impact and other suitable data.

Weather forecast polygons 504 is a dataset that receives data that identifies weather forecasts as a function of location polygons and that generate data for processing by a predictive spatiotemporal risk model as discussed herein, or other suitable risk models.

Hazard 506 can be implemented as one or more algorithms operating on a processor that receive data from weather forecast polygons 504 and generates data that represents a probability of occurrence of a severe weather condition with a selected threat intensity. In one example embodiment, hazard 506 can implement a predictive spatiotemporal risk model as discussed herein, or other suitable risk models.

Risk 508 can be implemented as one or more algorithms operating on a processor that receive data defining hazard and vulnerability of power systems due to vegetation and that generates risk data for use in determining an optimal tree trimming schedule.

Vulnerability 510 can be implemented as one or more algorithms operating on a processor that receive training set data and that generate data defining a conditional probability of the consequence of a vegetation-caused outage in the distribution network if and when severe weather is present.

Economic impact 512 can be implemented as one or more algorithms operating on a processor that receive data training set data and that generate data defining an estimated economic impact resulting from a vegetation-caused outage in the distribution network if and when severe weather is present.

Optimal tree trimming scheduler 514 can be implemented as one or more algorithms operating on a processor that receive economic impact data and risk data and that generates an optimal tree trimming schedule to reduce the risk of an outage, as a function of data processed using a predictive spatiotemporal risk model as discussed herein, or other suitable risk models. In one example embodiment, optimal tree trimming scheduler 514 can generate real-time instructions for work crews that includes locations where the work crew should report to, time periods that the tree trimming schedule is effective for and other suitable data. A user interface generated on a remote terminal can include one or more operator alerts to notify the operator that prior directions have changed, and a second user interface can be provided for the operator to generate image data or other suitable data that can be used to determine the accuracy of predicted levels of vegetation or other suitable data.

In operation, system 500 can be used for real-time data processing. Although system 500 is shown as a process, a person of skill in the art will recognize that it can also or alternatively be implemented as a state diagram, an object oriented diagram, a ladder chart, in other suitable programming paradigms or in a suitable combination of such programming paradigms.

Systems 400 and 500 present an overview of the temporal correlation module containing two major parts: 1) historical data processing, and 2) real-time data processing. The final product of historical data processing is a training list for the prediction algorithm. The real-time data processing generates input data for the real-time risk maps by generating the data for hazard, vulnerability, and economic impact that feeds the dynamic tree trimming scheduler.

Temporal resolution can be indexed by the occurrence of outages, where relevant information can be identified and extracted. In this example embodiment, the data points that are closest in time can be chosen from each set individually. For example, in the case of historical weather data, the closest data points can be within one minute of outage, whereas the closest vegetation maps could be up to several weeks apart.

A predictive spatiotemporal risk model can then be generated. For every moment of time, each network component is assigned a state of risk value. To enable spatiotemporal analysis, the state of risk R can be defined as follows:

R (G, t)=P [T (G, t)]·P [C (G, t) |T(G, t)] Equation (1)

where G represents the longitude and latitude of a single element, and t represents the moment in time for which the observation is made. A unique state of risk value can be assigned to each distribution feeder section. T(G, t) represents the threat intensity. Threat intensity is defined as a qualitative metric of the weather condition severity. The first term in equation (1) marked P[T(G, t)] is a hazard probability. Hazard represents the probability of occurrence of a severe weather condition with the selected threat intensity. The second term marked P[C (G, t) |T(G, t)] is network vulnerability, where C (G, t) is an occurrence of a consequence. Vulnerability is a conditional probability of the consequence (vegetation-caused outage) in the distribution network if and when severe weather is present.

In this disclosure, the economic impact can be calculated separately from the Risk and included in the optimal tree trimming scheduler as one of the optimization constrains.

In equation 1, P[T(G, t)] is a hazard, calculated based on the weather forecast data for a specific time and location. Data from the National Digital Forecast Database (NDFD) or other suitable data sources can be used. The database can contain the forecast up to 7 days in the future with time resolution of 3 hours, or other suitable data, and an updated forecast can be provided every 3 hours or at other suitable intervals. The spatial resolution of the weather forecast data can be 5 km or other suitable values. Because the weather forecast data is updated every 3 hours with maximum resolution of 3 hours, the risk maps are generated with the same 3 hours resolution.

The following parameters or other suitable parameters can be observed: wind speed, direction, and gust, temperature, relative humidity, convective hazard outlook, probability of critical fire, probability of dry lightning, hail probability, tornado probability, probability of severe thunderstorms, damaging thunderstorm wind probability, extreme hail probability. Based on the values of the observed parameters, a threat level can be classified into 6 groups from 0 to 5, where 0 represents normal weather conditions without any potentially severe elements, and 5 represents extremely severe weather conditions. K-means clustering can be used for classification into 6 groups, which enables the construction of hazard consequence levels from the individual weather parameters. In this manner, multiple different parameters can be combined into a single parameter “Threat Intensity” with 6 different states. Clustering can be done using historical weather data or other suitable data, where different configurations of weather parameters are associated with their measured impact on the outage occurrence. A hazard classification can be constructed as a heat map, where each threat level has an assigned probability of occurrence determined based on weather forecast. The construction of heat map can be implemented using the following two steps or in other suitable manners: 1) construct a probability matrix (e.g. 0%-20% extremely unlikely; 20%-40% highly unlikely; 40% to 60% doubtful; 60% to 80% somewhat likely and 80% to 100% very likely) and 2) construct a threat intensity matrix (e.g. category 0—no impact on the network; category 1 minor impact; category 2—moderate impact; category 3—severe impact, and so forth). Hazard values can range from extremely low to extremely high, with a suitable number of levels in between.

A GCRF model or other suitable models can be used for the prediction of network vulnerability that uses a weighted graph as a data structure, which enables the exploitation of spatial similarities between the nodes for the improved prediction capability. The data are processed in sequential order created during the temporal correlation of data. The GCRF algorithm or other suitable algorithms are capable of processing partially observed data, which is of benefit since within the collected data, several historical outage instances may be missing some of the weather parameters.

The GCRF model or other suitable models can be used to predict a state of vegetation impact, denoted y, based on historical measurements in the input vector x., and can express the conditional distribution as:

$$P ( y \vert x ) = \frac{1}{Z} exp ( - {\sum }_{i = 1}^{N} {\sum }_{k = 1}^{K} {{α}_{k} ( {y}_{i} - {R}_{k} ( x ) )}^{2} - - {\sum }_{i , j} {\sum }_{l = 1}^{L} {β}_{l} {e}_{ij}^{( l )} {S}_{ij}^{( l )} ( x ) {( {y}_{i} - {y}_{j} )}^{2} ) \qquad Equation ( 2 )$$

where Z is a normalization constant, x is a set of input variables coming from historical measurements, y is a set of output variables, N is a total number of nodes (line sections) in the network graph, Rk are unstructured models where k is the number of predictors, Sᵢⱼ represent similarities between outputs at nodes i and j determined based on their geographical distance, L is a number of branches, α are parameters of the association, and β are the interaction potentials.

The following historical measurements or other suitable measurements can be stored in the input vector x: wind speed, wind direction, wind gust, precipitation, temperature, humidity, pressure, vegetation distance to the line section, vegetation spread, vegetation growth rate, vegetation health index, pole height, tree trimming period, time since last tree trimming, outage duration, number of customers affected. The output y of the algorithm is the predicted state of vegetation impact on the feeder section.

The parameters α and β from equation 2 can be estimated by maximizing the conditional log-likelihood from the training set ((3) and (4) below), and applying the gradient descent optimization algorithm or using any other suitable approach:

$$L ( α , β ) = \sum log P ( y \vert x ) \qquad Equation ( 3 )$$

$$( α , β ) = {arg max}_{α , β} ( L ( α , β ) ) \qquad Equation ( 4 )$$

Historical outages are an integral part of the vulnerability. The prediction of future vulnerability is done based on the knowledge collected from the previous outages. The historical outage data contains information about the duration of the outage and the number of customers affected by it. This information guides the prediction algorithm to generate higher vulnerability levels in the cases where more customers were affected by the outage and for the greater duration.

In one example embodiment, two types of costs can be associated with the tree trimming: 1) a periodic tree trimming cost that has a preset value, since it follows a predetermined schedule, and 2) a reactive tree trimming cost that includes different components, such as a) only the faulted area is trimmed, and b) an entire circuit is trimmed. Reactive tree trimming cost varies depending on the events in the network.

The disclosed optimization model minimizes the overall risk of the system while maintaining the budget allocated for the periodic tree trimming. To achieve that goal, a quarterly periodic tree trimming schedule is designed based on a risk prediction for the next 3 months. The time instances when the risk map is created are every three hours during a three-month period. A total of T time instances is thus created each quarter. The risk can be calculated for each of the N feeder sections, and an optimized tree trimming schedule can be determined by solving the following optimization problem:

$$max \{ R = {\sum }_{t = 1}^{T} \frac{1}{N} {\sum }_{n = 1}^{N} Δ {R}_{n , t} \cdot {F}_{n , t} \} \qquad Equation ( 5 )$$

$$\begin{matrix}Fn , t = 0 , section n not trimmed at time t \\ 1 , section n is trimmed at time t\end{matrix}$$

where ΔR_{n,θ}=R_{n,(θ-1)}−R_{n,θ} is the difference in risk value for feeder n before and after the tree trimming is performed. The following constraints are enforced:

$${\sum }_{t = 1}^{T} {\sum }_{n = 1}^{N} {F}_{n , t} \cdot {PC}_{n , t} \leq PA \qquad Equation ( 6 )$$

$$For t = 1 , … , T , {\sum }_{n = 1}^{N} {F}_{n , t} \leq 1 \qquad Equation ( 7 )$$

where R is a total reduction in risk, PC_{n,t} is the cost of tree trimming of section n in the time instance t; and PA is a total budget allocated for the periodic tree trimming during the observed quarter. The optimization problem is nonlinear, and it can be solved using an enhanced linear programming relaxation with the Lagrangean relaxation plus heuristic method or other suitable methods.

While a reduction in reactive tree trimming cost is not an explicit goal of the optimization problem, it can be calculated to check the impact of risk reduction on the reduction in reactive tree trimming cost. To do that, the reactive tree trimming orders are iterated and for each one it was checked if the developed tree trimming scheduler recommended trimming of the area prior to the outage. If an area is part of the recommended tree trimming schedule in a time frame before the reactive tree trimming was performed, the reactive tree trimming cost is deducted from the total.

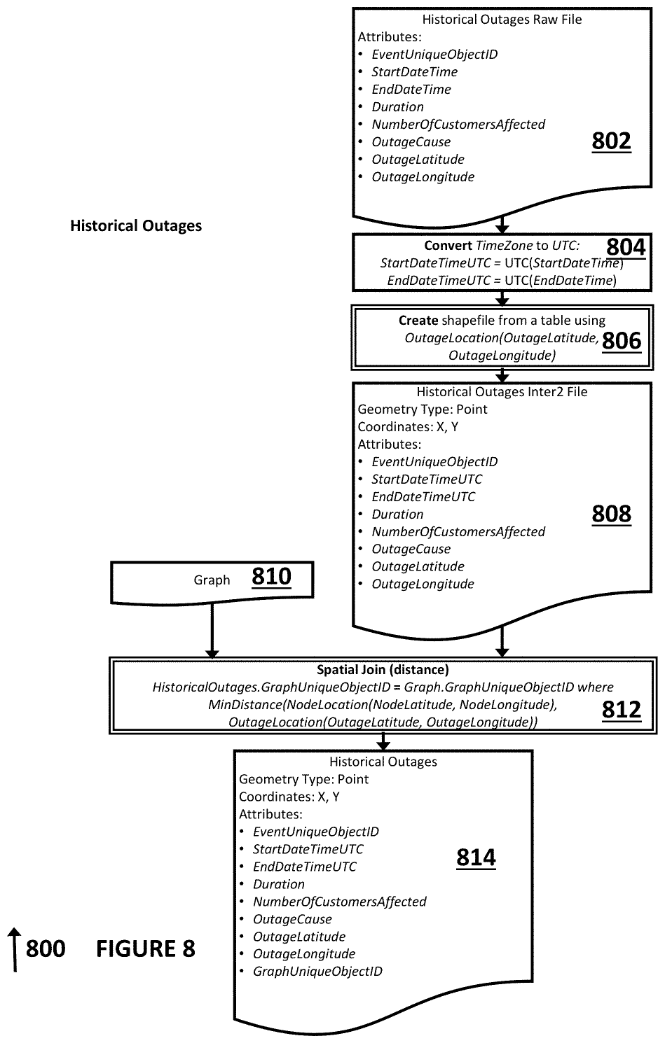

FIG. 6 is a diagram of a system 600 for extracting power line and distribution pole data for use with the disclosed risk management system and method, in accordance with an example embodiment of the present disclosure. System 600 provides the technical advantage of processing commonly available existing data for use with the disclosed risk management system and method without requiring additional processing or interrupting existing processes.

As shown in detail 614, a circuit includes line sections and poles, and data defining the distribution circuits are typically available from a utility company such as a transmission and distribution services provider. In one example embodiment, distribution lines system 602 can be implemented on a special purpose processor and can be configured to receive distribution lines raw data, such as a shapefile or any other suitable format that defines 1) geometry type: line, 2) coordinates: X, Y, 3) attributes, such as: LineSectionUniqueObjectID for a line section unique object identifier, NominalVoltage for a nominal voltage, CircuitID for a circuit identifier, ConductorCount for a number of conductors, ConductorSize for a conductor size, ConductorMaterial for conductor material, LineInstallationDate for a date that the line was installed, LineLength for a length of the line, Pole1ID for a first pole identifier associated with the line, Pole2ID for a second pole identifier associated with the line, and other suitable data.

Midpoint calculator 604 can be implemented on a special purpose processor and can be configured to receive data from distribution lines system 602 and to generate line midpoint data, such as NodeLatitude for a line midpoint latitude and NodeLongitude for a line midpoint longitude, or other suitable data. Midpoint writer 606 can be implemented on a special purpose processor and can be configured to write the line midpoint data and other suitable data.

Distribution lines final file system 608 can receive the data from distribution lines system 602 and midpoint calculator 604 and can generate a file that includes the data from distribution lines system 602 and NodeLatitude for a midpoint node latitude and NodeLongitude for a midpoint node longitude, and other suitable data. The data that is added to distribution lines system 602 data thus allows the distribution line data that is typically generated by a utility to be used with the disclosed risk management system and method, by processing the existing data to generate data that is required for use with the present disclosure. Distribution poles system 610 and distribution poles final file system 612 can be used to generate additional data, to provide data for use in processing distribution lines system 602 data or for other suitable functions.

In operation, system 600 can be used for utility data processing. Although system 600 is shown as a process, a person of skill in the art will recognize that it can also or alternatively be implemented as a state diagram, an object oriented diagram, a ladder chart, in other suitable programming paradigms or in a suitable combination of such programming paradigms.

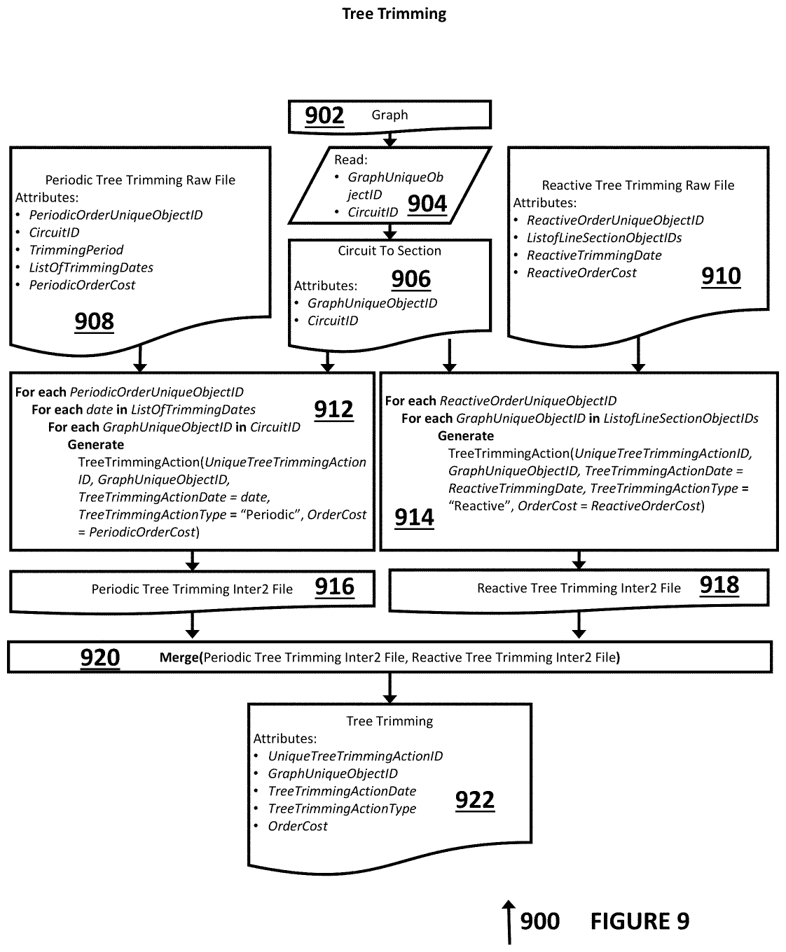

FIG. 7 is a diagram of a system 700 for graphing power line and distribution pole data for use with the disclosed risk management system and method, in accordance with an example embodiment of the present disclosure. System 700 provides the technical advantage of processing commonly available existing data for use with the disclosed risk management system and method without requiring additional processing or interrupting existing processes.

As shown in detail 710, a graph node includes pole data, line data and a line midpoint, which can be used with the disclosed risk management system and method. A graph system 708 generates graph files from data received from distribution lines final file system 702 and distribution poles final file system 704 and processed by join system 706, which generates Lines.Pole1ID that includes Poles.PoleUniqueObjectID and Lines.Pole2ID that includes Poles.PoleUniqueObjectID, and includes 1) Geometry Type: Line, 2) Coordinates: X, Y, 3 Attributes: GraphUniqueObjectID for a line section unique object ID, NominalVoltage for a nominal voltage, CircuitID for a circuit identifier, ConductorCount for a number of conductors, ConductorSize for a conductor size, ConductorMaterial for a conductor material, LineInstallationDate for a line installation, LineLength for a line length, NodeLatitude for a graph node latitude, NodeLongitude for a graph node longitude, Pole1ID for a first graph pole identifier, Pole1Material for a pole material associated with the first graph pole identifier, Pole1Height for a pole height associated with the first graph pole identifier, Pole1InstallationDate for an installation data associated with the first pole identifier, Pole1Latitude for a latitude associated with the first pole identifier, Pole1Longitude for a longitude associated with the first pole identifier, Pole2ID for a second graph pole identifier, Pole2Material for a pole material associated with the second graph pole identifier, Pole2Height for a pole height associated with the second graph pole identifier, Pole2InstallationDate for an installation data associated with the second pole identifier, Pole2Latitude for a latitude associated with the second pole identifier, Pole2Longitude for a longitude associated with the second pole identifier, and other suitable data.

Detail 712 provides an example of how the risk management system and method of present disclosure can be used to create a graph incident matrix and other suitable data. A final graph file is used to calculate a distance between all node midpoints using NodeLocation (NodeLatitude, NodeLongitude), which is used to generate a graph incidence matrix table, such as for graph nodes 1, 2, 3, 4 through N as shown or in other suitable manners.

In operation, system 700 can be used for utility data processing. Although system 700 is shown as a process, a person of skill in the art will recognize that it can also or alternatively be implemented as a state diagram, an object oriented diagram, a ladder chart, in other suitable programming paradigms or in a suitable combination of such programming paradigms.

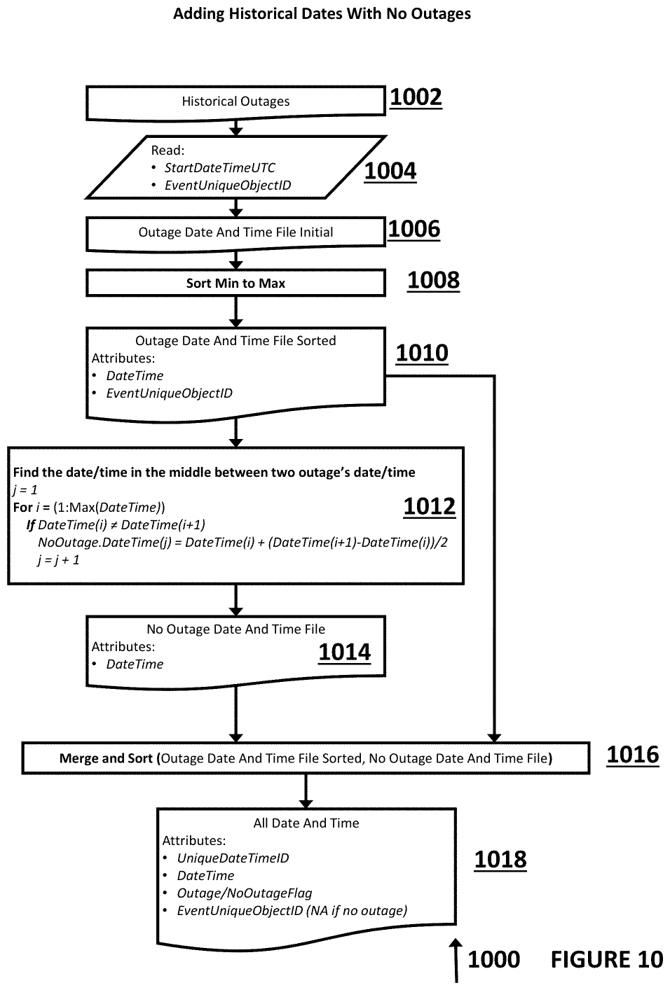

FIG. 8 is a diagram of a system 800 for generating historical outage data for use with the disclosed risk management system and method, in accordance with an example embodiment of the present disclosure. System 800 provides the technical advantage of processing commonly available existing data for use with the disclosed risk management system and method without requiring additional processing or interrupting existing processes.

Historical outages raw data system 802 can generate a historical outages raw data file that can include a table with attributes: 1) EventUniqueObjectID for a event unique object identifier, 2) StartDateTime for an event start time and date, 3) EndDateTime for an event end time and date, 4) Duration for an event duration, 5) NumberOfCustomersAffected for a number of customers affected by the event, 6) OutageCause for an outage cause, 7) OutageLatitude for an outage latitude, 8) OutageLongitude for an outage longitude and other suitable data. This data is processed by time zone conversion system 804 to convert time zone variables to a predetermined standard time zone such as the coordinated universal time zone, and by file system 806 to generate an outage file using outage latitude and longitude data and other suitable data. Intermediate file system 808 is used to join the data with data from a graph file system 810 using a spatial join system 812, which generates HistoricalOutages.GraphUniqueObjectID for a graph unique object identifier and adds it to the historical outage data, where MinDistance is a function of a node location having a node latitude and node longitude and OutageLocation having a outage latitude and outage longitude, that calculates the shortest distance between NodeLocation and OutageLocation based on their geographical coordinates (Longitude and Latitude),or other suitable data. A historical outages shapefile system 814 receives the data and generates an output that includes the graph object identifier of the closest node and other suitable data.

In operation, system 800 can be used for utility data processing. Although system 800 is shown as a process, a person of skill in the art will recognize that it can also or alternatively be implemented as a state diagram, an object oriented diagram, a ladder chart, in other suitable programming paradigms or in a suitable combination of such programming paradigms.

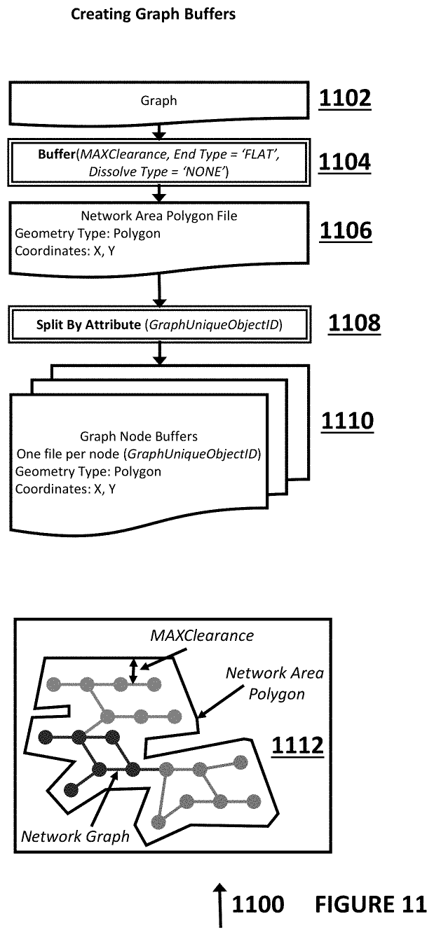

FIG. 9 is a diagram of a system 900 for generating tree trimming data for use with the disclosed risk management system and method, in accordance with an example embodiment of the present disclosure. System 900 provides the technical advantage of processing commonly available existing data for use with the disclosed risk management system and method without requiring additional processing or interrupting existing processes.

Graph file system 902 provides data to read file system, 904, which is used by circuit to section system 906 to generate a table that includes Attributes of 1) GraphUniqueObjectID for a graph unique object identifier, CircuitID for a circuit identifier and other suitable data. System 912 then generates for each periodic order unique object identifier, date in a list of trimming dates and circuit identifier of a graph unique object identifier received from periodic tree trimming system 908 1) a TreeTrimmingAction for each unique tree trimming action identifier and GraphUniqueObjectID, a TreeTrimmingActionDate having a date, a TreeTrimmingActionType having a value of “Periodic” and an OrderCost having a periodic order cost. System 914 generates for each reactive order unique object identifier and graph unique object identifier received from a list of line section object identifiers received from reactive tree trimming system 910 TreeTrimmingAction as a function of a unique tree trimming action identifier and a graph unique object identifier, TreeTrimmingActionDate for a reactive trimming date, TreeTrimmingActionType having a value of “Reactive”, OrderCost for a reactive order cost and other suitable data.

Periodic intermediate data file system 916 and reactive intermediate data file system 918 receive the data generated by system 912 and 914, respectively, and provide data to merge system 920 to generate a tree trimming table 922 having attributes of UniqueTreeTrimmingActionID for a unique tree trimming action identifier, GraphUniqueObjectID for a graph unique object identifier, TreeTrimmingActionDate for a tree trimming action date, TreeTrimmingActionType for a tree trimming action type, OrderCost for an order cost, and other suitable data.

In operation, system 900 can be used for utility data processing. Although system 900 is shown as a process, a person of skill in the art will recognize that it can also or alternatively be implemented as a state diagram, an object oriented diagram, a ladder chart, in other suitable programming paradigms or in a suitable combination of such programming paradigms.

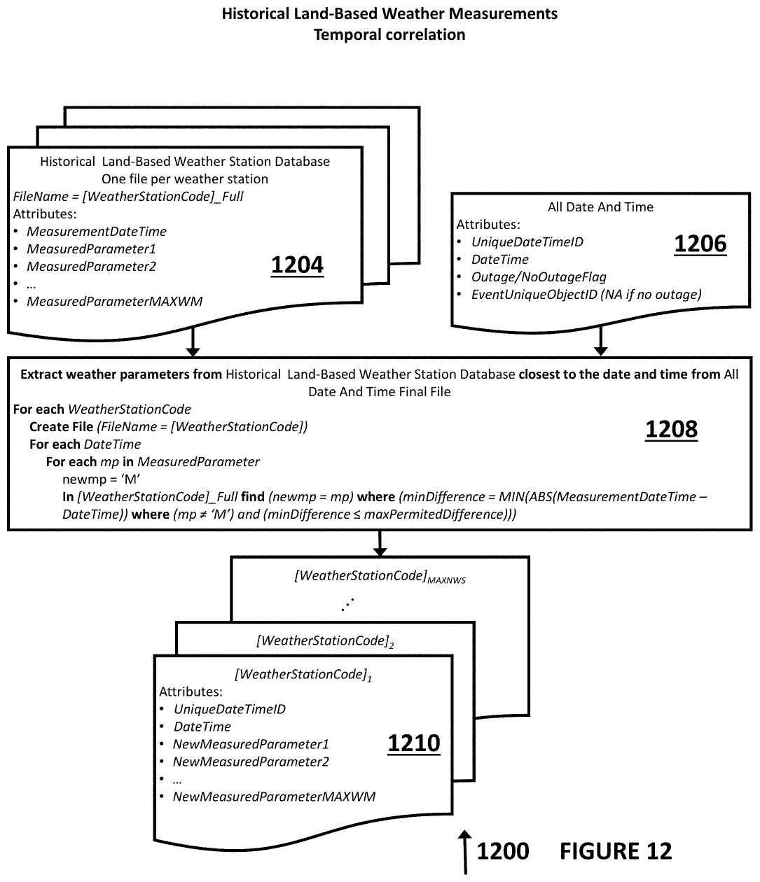

FIG. 10 is a diagram of a system 1000 for adding historical data with no outages for use with the disclosed risk management system and method, in accordance with an example embodiment of the present disclosure. System 1000 provides the technical advantage of processing commonly available existing data for use with the disclosed risk management system and method without requiring additional processing or interrupting existing processes.

System 1002 generates a historical outages file from which a start date and time adjusted to UTC and an event unique object identifier is read by 1004 to generate an initial outage date and time table at 1006. The table is sorted from minimum to maximum at 1008 and a sorted outage date and time table is generated 1010 with attributes of DateTime for a date and time and EventUniqueObjectID for an event unique object identifier. At 1012, the date and time in the middle between the date and time for two outages is found by implementing the algorithm:

```
j = 1
For i = (1:Max(DateTime))
{
  If DateTime(i) ≠ DateTime(i+1)
    {
      NoOutage.DateTime(j) = DateTime(i) + (DateTime(i+1) −
      DateTime(i))/2
      j = j + 1
    }
}
```

At 1014, table is generated for dates and times with no outages, which is merged and sorted at 1016 with outage date and time data to generate a combined data table at 1018.

In operation, system 1000 can be used for utility data processing. Although system 1000 is shown as a process, a person of skill in the art will recognize that it can also or alternatively be implemented as a state diagram, an object oriented diagram, a ladder chart, in other suitable programming paradigms or in a suitable combination of such programming paradigms.

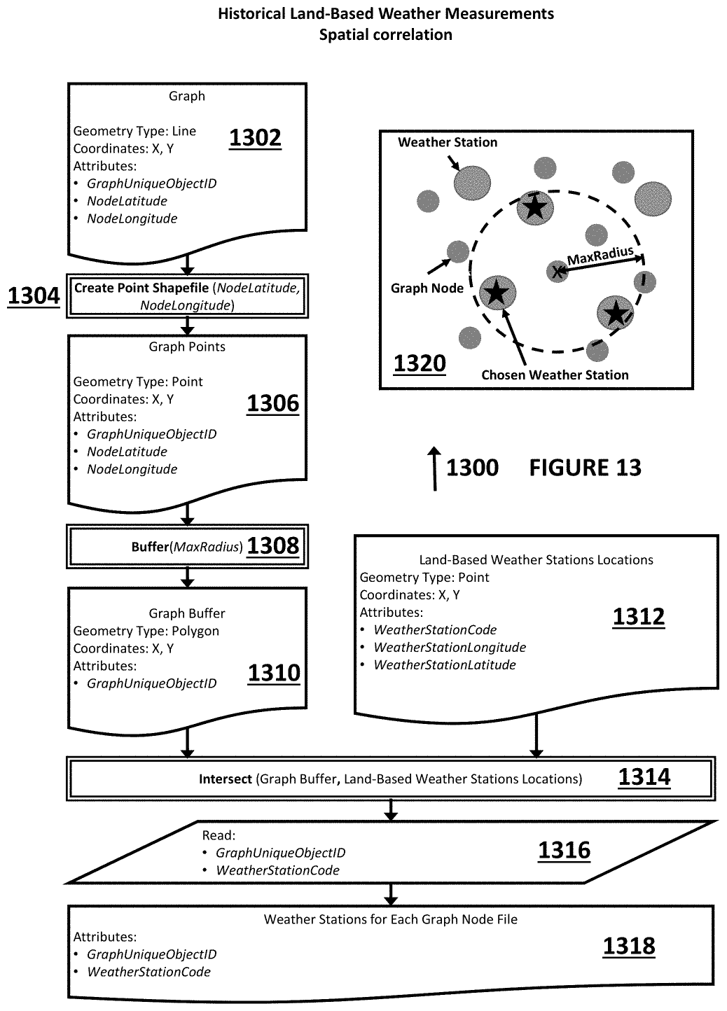

FIG. 11 is a diagram of a system 1100 for creating graph buffers for use with the disclosed risk management system and method, in accordance with an example embodiment of the present disclosure. System 1100 provides the technical advantage of processing commonly available existing data for use with the disclosed risk management system and method without requiring additional processing or interrupting existing processes.

As shown in inset 1112, a maximum clearance is defined between a network area polygon and a network graph. The graph file is received from 1102 by buffer 1104, which generates a buffer containing maximum clearance values having an end type of flat and a dissolve type of none. A network area polygon file 1106 is then provided to split by attribute 1108 to generate a graph node buffer at 1110 having one file per node (GraphUniqueObjectID).

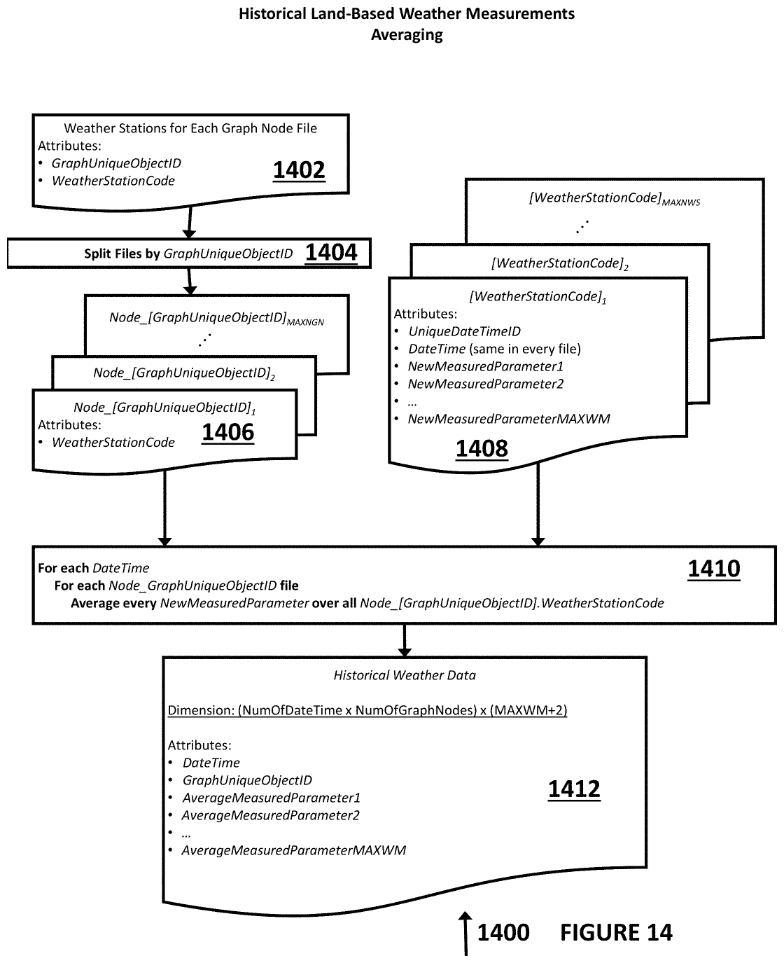

FIG. 12 is a diagram of a system 1200 for temporal correlation of historical land-based weather measurements for use with the disclosed risk management system and method, in accordance with an example embodiment of the present disclosure. System 1200 provides the technical advantage of processing commonly available existing data for use with the disclosed risk management system and method without requiring additional processing or interrupting existing processes.

System 1208 receives historical land-based weather station database from 1204, such as one file per weather station, each having the following attributes: 1) FileName associated with the weather station code, MeasurementDateTime for the date and time of each measurement, and a plurality of MeasuredParameter variables for measured parameters. System 1208 also receives all date and time file from 1206, which include attributes such as: UniqueDateTimeID for a unique time and date identifier, DateTime for an associated date and time, Outage/NoOutageFlag to indicate whether there was an outage, EventUniqueObjectID for an outage (not applicable if no outage) and other suitable data. System 1208 extracts weather parameters from the historical land-based Weather station database closest to the date and time from the all date and time final file, and performs the following process or other suitable processes

```
For each WeatherStationCode:
{
Create File (FileName = [WeatherStationCode])
  For each DateTime
  {
    For each mp in MeasuredParameter
    {
      newmp = ‘M’
      In [WeatherStationCode]_Full find (newmp = mp) where
      (minDifference = min(abs(MeasurementDateTime −
      DateTime)) where (mp ≠ ‘M’) and (minDifference ≤
      maxPermitedDifference)))
    }
  }
}
```

At 1210, the following attributes or other suitable data is generated for each WeatherStationCode: Attributes: 1) UniqueDateTimeID for a unique date and time identifier, 2) DateTime for the date and time, and 3) NewMeasuredParameter1-N for a plurality of measured parameter values.

In operation, system 1200 can be used for utility data processing. Although system 1200 is shown as a process, a person of skill in the art will recognize that it can also or alternatively be implemented as a state diagram, an object oriented diagram, a ladder chart, in other suitable programming paradigms or in a suitable combination of such programming paradigms.

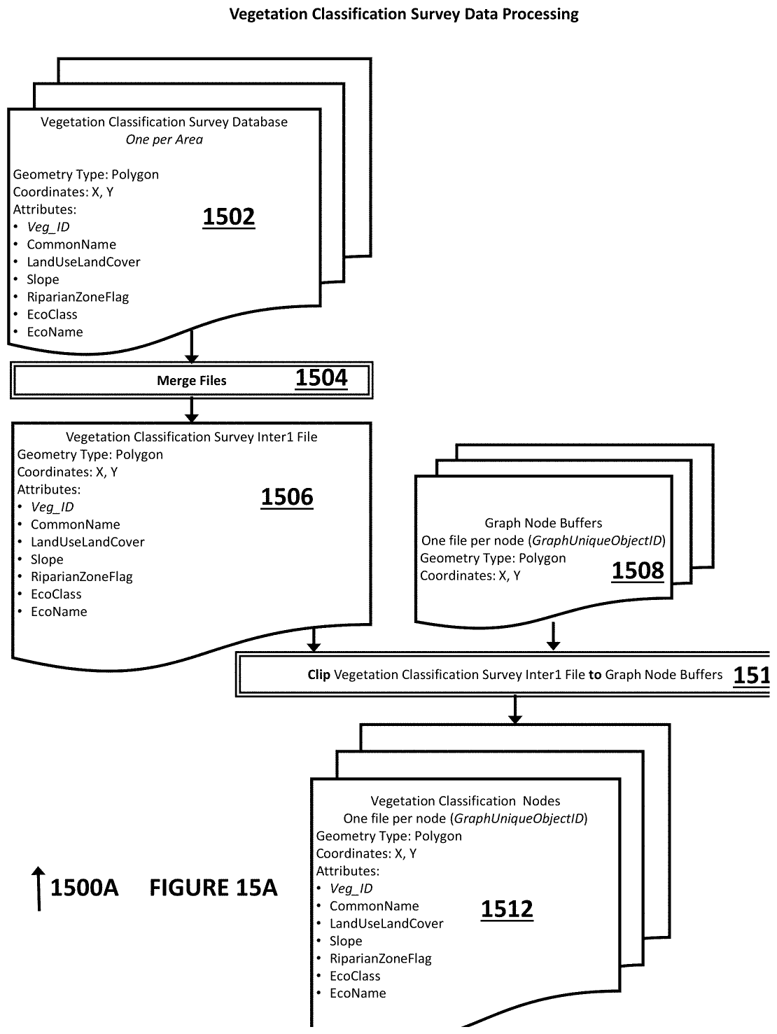

FIG. 13 is a diagram of a system 1300 for spatial correlation of historical land-based weather measurements for use with the disclosed risk management system and method, in accordance with an example embodiment of the present disclosure. System 1300 provides the technical advantage of processing commonly available existing data for use with the disclosed risk management system and method without requiring additional processing or interrupting existing processes.

As shown in inset 1320, each graph node will have an associated maximum radius within which one or more weather stations may be located. System 1302 receives for each graph file data for a line geometry type with (X, Y) coordinates and attributes GraphUniqueObjectID for a graph unique object identifier, NodeLatitude for a node latitude, NodeLongitude for a node longitude and other suitable data. A point file is created at 1304 having values for NodeLatitude, NodeLongitude and other suitable data. System 1306 receives for each graph point file data for a point geometry type with (X, Y) coordinates and attributes GraphUniqueObjectID for a graph unique object identifier, NodeLatitude for a node latitude, NodeLongitude for a node longitude and other suitable data.

At 1308, the data is buffered for each graph node as a function of the maximum radius, and at 1310, a graph buffer file is generated containing a polygon geometry type, coordinates (X, Y) and attributes GraphUniqueObjectID for a graph unique object ID and other suitable data.

At 1312, a point file for land-based weather stations locations is generated that includes point geometry type, (X, Y) coordinates and attributes of WeatherStationCode for a weather station code, WeatherStationLongitude for weather station longitude and WeatherStationLatitude for weather station latitude.

At 1314, the graph buffer and land-based weather stations locations are processed to identify intersections. At 1316, the GraphUniqueObjectID and WeatherStationCode are read from the intersected data.

At 1318, a table is generated for weather stations for each graph node file that includes the attributes GraphUniqueObjectID for graph object identifiers and WeatherStationCode for the weather station code.

In operation, system 1300 can be used for utility data processing. Although system 1300 is shown as a process, a person of skill in the art will recognize that it can also or alternatively be implemented as a state diagram, an object oriented diagram, a ladder chart, in other suitable programming paradigms or in a suitable combination of such programming paradigms.

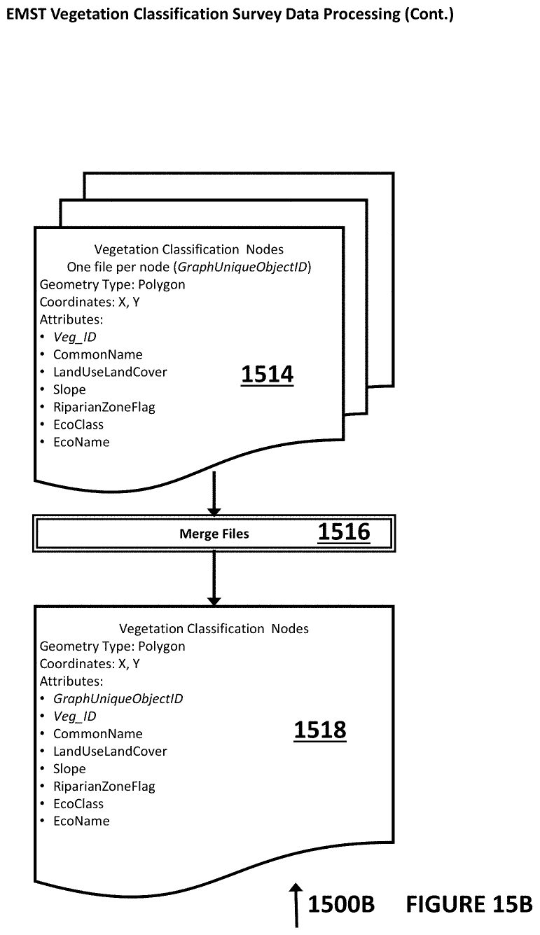

FIG. 14 is a diagram of a system 1400 for averaging of historical land-based weather measurements for use with the disclosed risk management system and method, in accordance with an example embodiment of the present disclosure. System 1400 provides the technical advantage of processing commonly available existing data for use with the disclosed risk management system and method without requiring additional processing or interrupting existing processes.

At 1402, a table is generated for weather stations for each graph node file that includes the attributes: 1) GraphUniqueObjectID for a graph unique object identifier and 2) WeatherStationCode for a weather station code. At 1404, the files are split by GraphUniqueObjectID, and at 1406, a node is generated for each GraphUniqueObjectID having the attribute WeatherStationCode.

At 1408, data is received from a plurality of weather stations, each having an associated WeatherStationCode for a weather station code and a plurality of attributes, including 1) UniqueDateTimeID for a unique date and time identifier, 2) DateTime for a date and time that is the same in every file, and 3) a plurality of NewMeasuredParameter fields for new values of measured parameters.

At 1410, an algorithm is implemented to generate average values for measured parameters, such as:

```
For each DateTime
{
  For each Node_GraphUniqueObjectID file
  {
    Average every NewMeasuredParameter over all
    Node_[GraphUniqueObjectID].WeatherStationCode
  }
},
```

or other suitable algorithms.

At 1412, a table of historical weather data is generated having dimensions: (NumOfDateTime×NumOfGraphNodes)×(MAXWM+2), where NumOfDateTime is a number of date and time values for the table, NumOfGraphNodes is a number of graph nodes for the table and MAXWM is the number of different measured attributes, and where the table attributes include: 1) DateTime, 2) GraphUniqueObjectID for a graph unique object ID and 3) a plurality of AverageMeasuredParameter values for the averaged measured parameters.

In operation, system 1400 can be used for utility data processing. Although system 1400 is shown as a process, a person of skill in the art will recognize that it can also or alternatively be implemented as a state diagram, an object oriented diagram, a ladder chart, in other suitable programming paradigms or in a suitable combination of such programming paradigms.

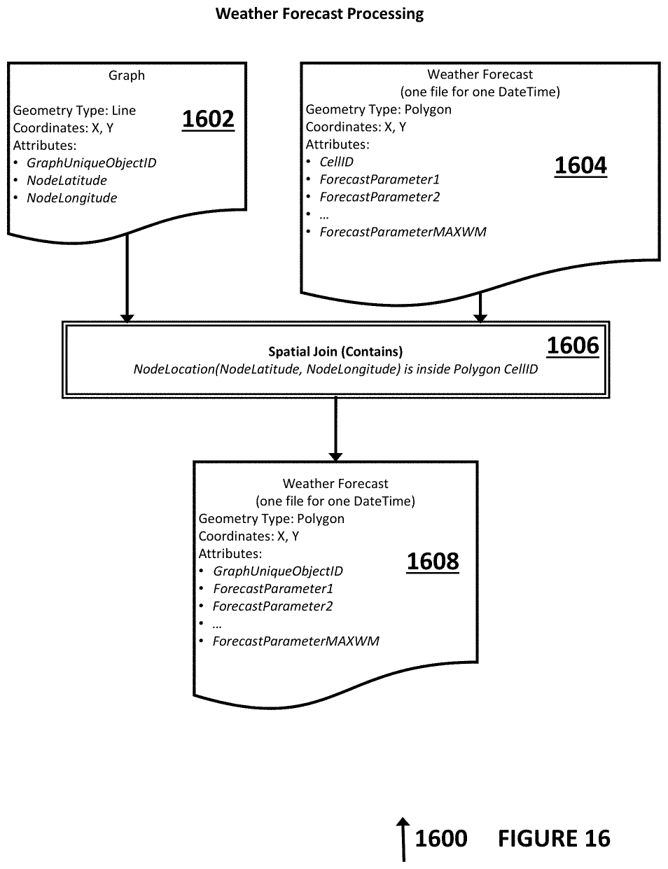

FIGS. 15A and 15B are a diagram of a system 1500A and 1500B for vegetation classification survey data processing for use with the disclosed risk management system and method, in accordance with an example embodiment of the present disclosure. System 1500A and 1500B provides the technical advantage of processing commonly available existing data for use with the disclosed risk management system and method without requiring additional processing or interrupting existing processes.

At 1502, Vegetation Classification Survey Database (for example an Ecological Mapping Systems of Texas (EMST) Database can be used) of files is generated for each predetermined area, such as in case of EMST 1) EastCentral for an east central area, 2) SouthCentral for a south central area, 3) WestGulf for a west gulf area and so forth, having a polygon geometry type, X, Y coordinates and attributes including: 1) Veg_ID for a vegetation identifier, 2) CommonName for a vegetation common name, 3) LandUseLandCover to identift the land use or land cover, 4) Slope for any slope, 5) RiparianZoneFlag to identify riparian zones, 6) EcoClass for ecological classification, 7) EcoName for an ecological name and so forth. Any other suitable Vegetation Classification Survey database can be used instead of EMST.

At 1504, the Vegetation Classification Survey files are merged, and at 1506 Vegetation Classification Survey intermediate files are generated having a polygon geometry type, X, Y coordinates and the same attributes as in 1502. At 1508, a graph node buffers shapefile database is generated having one file per node with a value of GraphUniqueObjectID for a graph unique object identifier, a polygon geometry type and X, Y coordinates.

At 1510, the EMST intermediate file is clipped to each graph node buffer individually. At 1512, vegetation classification nodes are generated for a file database with one file per node having an associated GraphUniqueObjectID, polygon geometry type, X, Y coordinates and the associated attributes.

1514 is the same as 1512 At 1516, the files are merged and at 1518, vegetation classification nodes are generated.

In operation, system 1500A and 1500B can be used for utility data processing. Although system 1500A and 1500B is shown as a process, a person of skill in the art will recognize that it can also or alternatively be implemented as a state diagram, an object oriented diagram, a ladder chart, in other suitable programming paradigms or in a suitable combination of such programming paradigms.

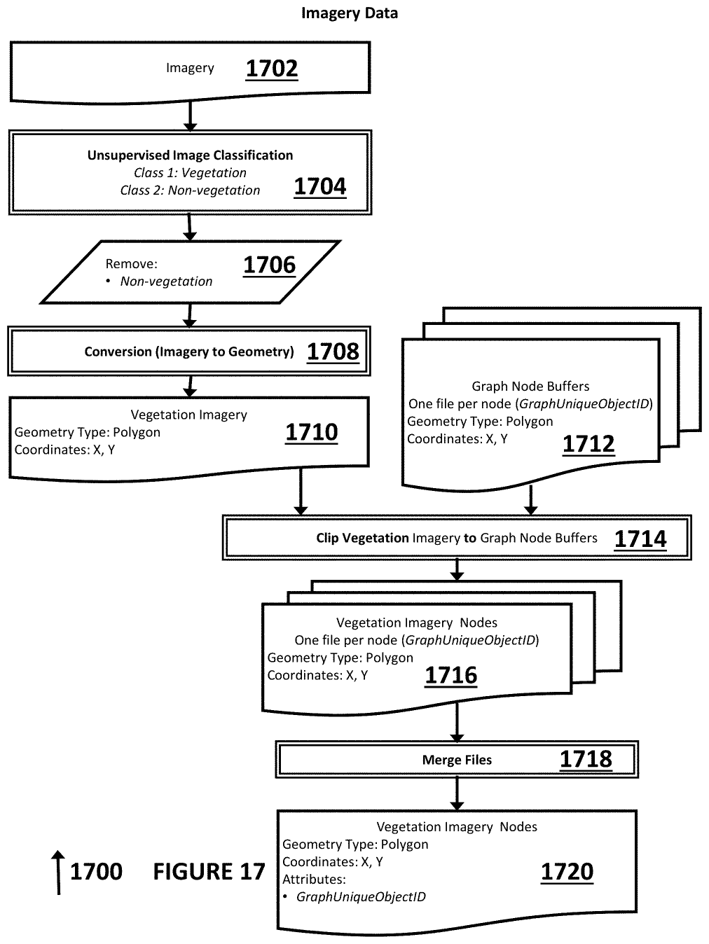

FIG. 16 is a diagram of a system 1600 for weather forecast processing for use with the disclosed risk management system and method, in accordance with an example embodiment of the present disclosure. System 1600 provides the technical advantage of processing commonly available existing data for use with the disclosed risk management system and method without requiring additional processing or interrupting existing processes.

At 1602, a graph file is generated with a line geometry type, X, Y coordinates and attributes that include: 1) GraphUniqueObjectID, 2) NodeLatitude and 3) NodeLongitude. At 1604, a weather forecast file is generated with one file for each value of DateTime, with a polygon geometry type, X, Y coordinates and attributes that include: 1) CellID for a cell identifier, and 2) ForecastParameterN for 1-N forecast parameters. At 1606, a spatial join function is performed on the graph file and the weather forecast file to generate NodeLocation for a node location as a function of NodeLatitude and NodeLongitude, inside a Polygon CellID. At 1608, a weather forecast file is generated, with one file for each value of DateTime, with a polygon geometry type, X, Y coordinates and attributes that include: 1) GraphUniqueObjectID and 2) ForecastParameterN for parameters 1-N.

In operation, system 1600 can be used for utility data processing. Although system 1600 is shown as a process, a person of skill in the art will recognize that it can also or alternatively be implemented as a state diagram, an object oriented diagram, a ladder chart, in other suitable programming paradigms or in a suitable combination of such programming paradigms.

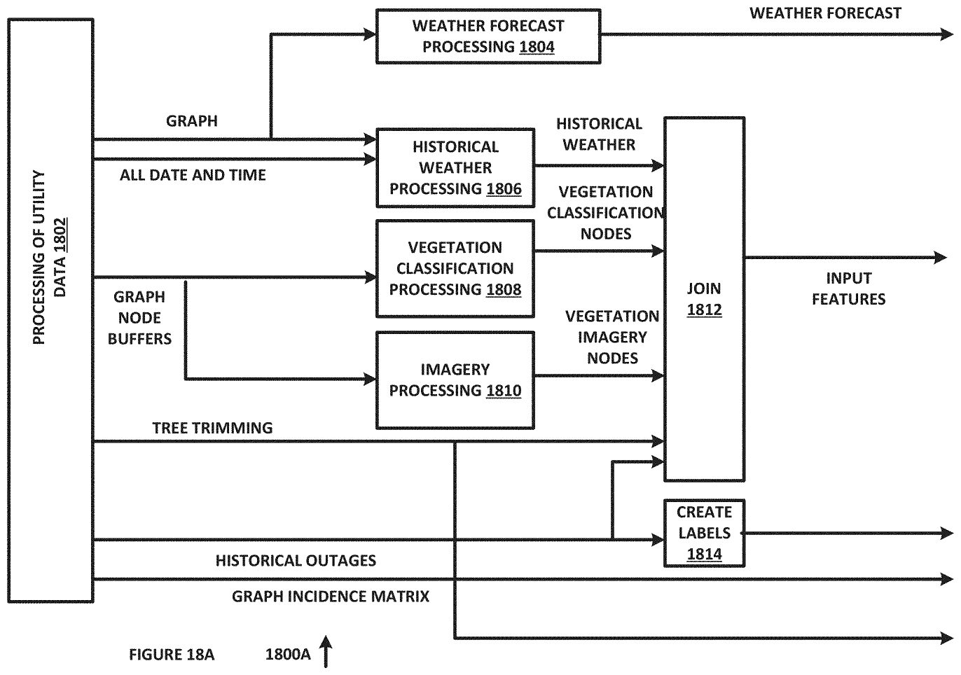

FIG. 17 is a diagram of a system 1700 for imagery data processing for use with the disclosed risk management system and method, in accordance with an example embodiment of the present disclosure. System 1400 provides the technical advantage of processing commonly available existing data for use with the disclosed risk management system and method without requiring additional processing or interrupting existing processes.

At 1702, imagery data is generated. At 1704, unsupervised image classification is performed on the imagery raster data to classify it as Class 1: vegetation, Class 2: non-vegetation or other suitable classes. At 1706, non-vegetation classes are removed and at 1708, the imagery files are converted to polygons.

At 1710, a vegetation imagery file is generated having a polygon geometry type and X, Y coordinates. At 1712, a file database of graph node buffers is generated, with one file per node having an attribute of GraphUniqueObjectID, with a polygon geometry type and X, Y coordinates.

At 1714, vegetation imagery is clipped to graph node buffers, and at 1716, a file database of vegetation imagery nodes is generated with one file per node, having an attribute of GraphUniqueObjectID, a polygon geometry type and X, Y coordinates. At 1718, the files are merged and at 1720, vegetation imagery nodes are generated with polygon geometry, X, Y coordinates and attributes that include GraphUniqueObjectID.

In operation, system 1700 can be used for utility data processing. Although system 1700 is shown as a process, a person of skill in the art will recognize that it can also or alternatively be implemented as a state diagram, an object oriented diagram, a ladder chart, in other suitable programming paradigms or in a suitable combination of such programming paradigms.

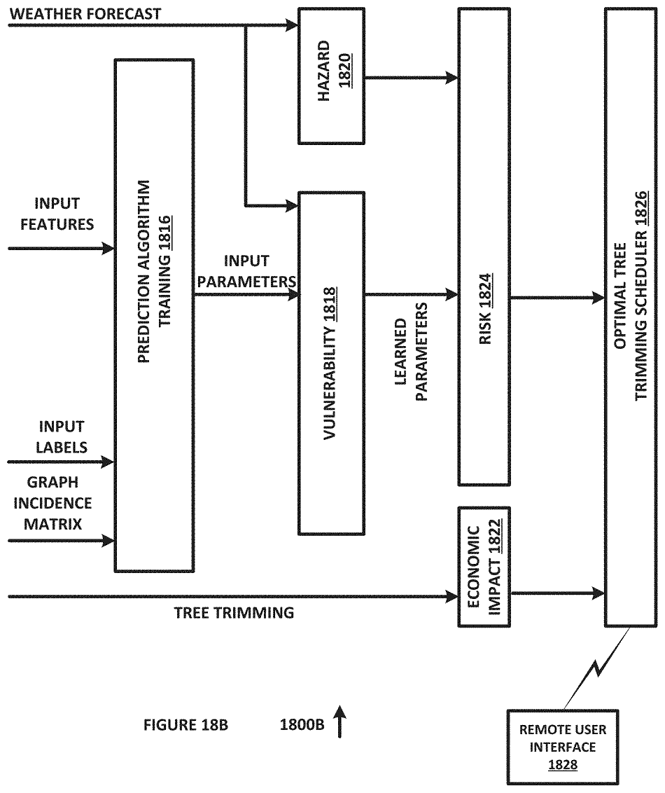

FIGS. 18A and 18B are a diagram of a system 1800A and 1800B for use with the disclosed risk management system and method, in accordance with an example embodiment of the present disclosure. System 1800A and 1800B provides the technical advantage of processing commonly available existing data for use with the disclosed risk management system and method without requiring additional processing or interrupting existing processes.

Processing of utility data system 1802 can be configured as one or more algorithms loaded into memory of a processor that cause the processor to perform the functions of accessing a utility database or databases and separating data required for other system components of systems 1800A and 1800B. System 1802 can implement one or more of the algorithms disclosed herein, including but not limited to the algorithmic processes discussed in FIGS. 6-11 or other suitable processes.

Weather forecast processing system 1804 can be configured as one or more algorithms loaded into memory of a processor that cause the processor to perform the functions of accessing one or more weather forecast databases and generating weather forecast data in a suitable format, such as those discussed in relation to one or more of the processes or algorithms discussed herein, including but not limited to FIG. 16.

Historical weather processing system 1806 can be configured as one or more algorithms loaded into memory of a processor that cause the processor to perform the functions of accessing one or more weather measurement databases and generating historical weather data in a suitable format, such as those discussed in relation to one or more of the processes or algorithms discussed herein, including but not limited to FIGS. 12-14.

Vegetation classification processing system 1808 can be configured as one or more algorithms loaded into memory of a processor that cause the processor to perform the functions of accessing one or more vegetation classification databases and generating vegetation classification data in a suitable format, such as those discussed in relation to one or more of the processes or algorithms discussed herein, including but not limited to FIGS. 15A and 15B.

Imagery processing system 1810 can be configured as one or more algorithms loaded into memory of a processor that cause the processor to perform the functions of accessing one or more imagery databases and generating vegetation imagery data in a suitable format, such as those discussed in relation to one or more of the processes or algorithms discussed herein, including but not limited to FIG. 17.

Join system 1812 can be configured as one or more algorithms loaded into memory of a processor that cause the processor to perform the functions of joining, merging, combining, interpolating or otherwise integrating historical weather data, vegetation classification data, vegetation imagery data, tree trimming data, historical outage data and other suitable data to generate input features for prediction algorithm training. In one example embodiment, join system 1812 can use an indexing attribute such as GraphUniqueObjectID to process the data or other suitable data, and can implement one or more of the processes or algorithms discussed herein or other suitable processes or algorithms.

Create labels system 1814 can be configured as one or more algorithms loaded into memory of a processor that cause the processor to perform the functions of receiving historical outage data and generating labelled data to identify periods with outages and periods with no outages, such as for use with prediction algorithm training in conjunction with input features or in other suitable manners. In one example embodiment, create labels system 1814 can implement one or more of the processes or algorithms discussed herein or other suitable processes or algorithms.

Prediction algorithm training system 1816 can be configured as one or more algorithms loaded into memory of a processor that cause the processor to perform the functions of receiving input features, input labels, a graph incidence matrix and other suitable data and generating learned parameters, such as those discussed and described in detail herein or other suitable processes and algorithms. In one example embodiment, prediction algorithm training system 1816 can implement a conditional random field (CRF) model such as GCRF, a linear chain CRF, a semi-Markov CRF, a latent-dynamic CRF or other suitable deep learning processes, such as neural networks.

Vulnerability system 1818 can be configured as one or more algorithms loaded into memory of a processor that cause the processor to perform the functions of receiving a training set data and generating data defining a conditional probability of the consequence of a vegetation-caused outage in the distribution network if and when severe weather is present, such as in accordance with the systems and processes disclosed and discussed herein or other suitable processes. In one example embodiment, vulnerability system 1818 can implement one or more of the processes or algorithms discussed herein or other suitable processes or algorithms.

Hazard system 1820 can be configured as one or more algorithms loaded into memory of a processor that cause the processor to perform the functions of receiving weather forecast data and generating data that represents a probability of occurrence of a severe weather condition with a selected threat intensity. In one example embodiment, hazard 506 can implement a predictive spatiotemporal risk model as discussed herein, or other suitable risk models.

Economic impact system 1822 can be configured as one or more algorithms loaded into memory of a processor that cause the processor to perform the functions of receiving tree trimming data and generating data defining an estimated economic impact resulting from a vegetation-caused outage in the distribution network if and when severe weather is present. In one example embodiment, economic impact system 1822 can implement one or more of the processes or algorithms discussed herein or other suitable processes or algorithms.

Risk system 1824 can be configured as one or more algorithms loaded into memory of a processor that cause the processor to perform the functions of receiving training set data and generating data defining a conditional probability of the consequence of a vegetation-caused outage in the distribution network if and when severe weather is present. In one example embodiment, risk system 1824 can implement one or more of the processes or algorithms discussed herein or other suitable processes or algorithms.

Optimal tree trimming scheduler system 1826 can be configured as one or more algorithms loaded into memory of a processor that cause the processor to perform the functions of receiving economic impact data and risk data generating an optimal tree trimming schedule to reduce the risk of an outage, as a function of data processed using a predictive spatiotemporal risk model as discussed herein, or other suitable risk models. In one example embodiment, optimal tree trimming scheduler system 1826 can implement one or more of the processes or algorithms discussed herein or other suitable processes or algorithms.

Remote user interface system 1828 can be configured as one or more algorithms loaded into memory of a processor that cause the processor to perform the functions of generating a user interface for a tree trimming crew with real-time updates and user interface controls. In one example embodiment, remote user interface system 1828 can be a vehicle mounted system that generates map data and directions for a work crew, such as to proceed to specified location and to perform tree trimming. Remote user interface system 1828 can receive real-time vehicle location data and can determine an optimal work crew for assignment. In this example embodiment, two or more work crews can be located close to a location where tree trimming is needed due to changing weather conditions, and remote user interface system 1828 can determine which crew is near to completing a current work assignment, which crew has not yet started a current work assignment or other suitable data to be used to generate assignment data. A crew that is twice as far away but which has completed a current assignment could thus be selected over a closer crew that is in the middle of an assignment with a slightly lower priority.

Remote user interface system 1828 can also generate one or more user interface controls to prompt a user to generate data for input to one or more system components of system 1800. In one example embodiment, system 1800 may obtain old or unreliable data that indicates that vegetation at a location needs to be trimmed. The work crew can receive a prompt from remote user interface system 1828 to take one or more pictures of the vegetation, and can re-route the work crew if the processed image data indicates that additional trimming is not as urgent as other areas. In this manner, remote user interface system 1828 facilitates the optimal allocation of work resources in response to real-time weather conditions.

As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

As used herein, “hardware” can include a combination of discrete components, an integrated circuit, an application-specific integrated circuit, a field programmable gate array, or other suitable hardware. As used herein, “software” can include one or more objects, agents, threads, lines of code, subroutines, separate software applications, two or more lines of code or other suitable software structures operating in two or more software applications, on one or more processors (where a processor includes one or more microcomputers or other suitable data processing units, memory devices, input-output devices, displays, data input devices such as a keyboard or a mouse, peripherals such as printers and speakers, associated drivers, control cards, power sources, network devices, docking station devices, or other suitable devices operating under control of software systems in conjunction with the processor or other devices), or other suitable software structures. In one exemplary embodiment, software can include one or more lines of code or other suitable software structures operating in a general purpose software application, such as an operating system, and one or more lines of code or other suitable software structures operating in a specific purpose software application. As used herein, the term “couple” and its cognate terms, such as “couples” and “coupled,” can include a physical connection (such as a copper conductor), a virtual connection (such as through randomly assigned memory locations of a data memory device), a logical connection (such as through logical gates of a semiconducting device), other suitable connections, or a suitable combination of such connections. The term “data” can refer to a suitable structure for using, conveying or storing data, such as a data field, a data buffer, a data message having the data value and sender/receiver address data, a control message having the data value and one or more operators that cause the receiving system or component to perform a function using the data, or other suitable hardware or software components for the electronic processing of data.

In general, a software system is a system that operates on a processor to perform predetermined functions in response to predetermined data fields. A software system is typically created as an algorithmic source code by a human programmer, and the source code algorithm is then compiled into a machine language algorithm with the source code algorithm functions, and linked to the specific input/output devices, dynamic link libraries and other specific hardware and software components of a processor, which converts the processor from a general purpose processor into a specific purpose processor. This well-known process for implementing an algorithm using a processor should require no explanation for one of even rudimentary skill in the art. For example, a system can be defined by the function it performs and the data fields that it performs the function on. As used herein, a NAME system, where NAME is typically the name of the general function that is performed by the system, refers to a software system that is configured to operate on a processor and to perform the disclosed function on the disclosed data fields. A system can receive one or more data inputs, such as data fields, user-entered data, control data in response to a user prompt or other suitable data, and can determine an action to take based on an algorithm, such as to proceed to a next algorithmic step if data is received, to repeat a prompt if data is not received, to perform a mathematical operation on two data fields, to sort or display data fields or to perform other suitable well-known algorithmic functions. Unless a specific algorithm is disclosed, then any suitable algorithm that would be known to one of skill in the art for performing the function using the associated data fields is contemplated as falling within the scope of the disclosure. For example, a message system that generates a message that includes a sender address field, a recipient address field and a message field would encompass software operating on a processor that can obtain the sender address field, recipient address field and message field from a suitable system or device of the processor, such as a buffer device or buffer system, can assemble the sender address field, recipient address field and message field into a suitable electronic message format (such as an electronic mail message, a TCP/IP message or any other suitable message format that has a sender address field, a recipient address field and message field), and can transmit the electronic message using electronic messaging systems and devices of the processor over a communications medium, such as a network. One of ordinary skill in the art would be able to provide the specific coding for a specific application based on the foregoing disclosure, which is intended to set forth exemplary embodiments of the present disclosure, and not to provide a tutorial for someone having less than ordinary skill in the art, such as someone who is unfamiliar with programming or processors in a suitable programming language. A specific algorithm for performing a function can be provided in a flow chart form or in other suitable formats, where the data fields and associated functions can be set forth in an exemplary order of operations, where the order can be rearranged as suitable and is not intended to be limiting unless explicitly stated to be limiting.

It should be emphasized that the above-described embodiments are merely examples of possible implementations. Many variations and modifications may be made to the above-described embodiments without departing from the principles of the present disclosure. All such modifications and variations are intended to be included herein within the scope of this disclosure and protected by the following claims.

What is claimed is:

1. A system for generating a dynamic tree trimming schedule, comprising:
a network vegetation model system operating on a first processor and configured to receive a network vegetation model and weather forecast data and to generate a real-time tree trimming schedule as a function of the network vegetation model and weather forecast data; and
a remote user interface operating on a second processor and configured to receive the real-time tree trimming schedule and to generate one or more user interface controls as a function of the real-time tree trimming schedule.

2. The system of claim 1 wherein the network vegetation model is generated using a plurality of transmission line polylines.

3. The system of claim 1 wherein the network vegetation model is generated using a plurality of weather polygons.

4. The system of claim 1 wherein the network vegetation model is generated using a plurality of vegetation polygons.

5. The system of claim 1 wherein the network vegetation model is generated using a plurality of vegetation polygons modified as a function of a growth rate.

6. The system of claim 1 wherein the remote user interface is configured to generate a map to a location where tree trimming should be performed.

7. The system of claim 1 wherein the remote user interface is configured to redirect a work crew from an existing location to a location where tree trimming should be performed.

8. The system of claim 1 wherein the remote user interface is configured to select a work crew from a plurality of work crews to travel to a location where tree trimming should be performed.

9. The system of claim 1 wherein the remote user interface is configured to direct a work crew to generate vegetation image data and to transmit the vegetation image data to the network vegetation model system.

10. A method for generating a dynamic tree trimming schedule, comprising:
receiving a network vegetation model and weather forecast data at a network vegetation model system operating on a first processor;
generating a real-time tree trimming schedule as a function of the network vegetation model and weather forecast data;
receiving the real-time tree trimming schedule at a remote user interface operating on a second processor;
generating one or more user interface controls at the remote user interface as a function of the real-time tree trimming schedule.

11. The method of claim 10 wherein the network vegetation model is generated using a plurality of transmission line polylines.

12. The method of claim 10 wherein the network vegetation model is generated using a plurality of weather polygons.

13. The method of claim 10 wherein the network vegetation model is generated using a plurality of vegetation polygons.

14. The method of claim 10 wherein the network vegetation model is generated using a plurality of vegetation polygons modified as a function of a growth rate.

15. The method of claim 10 wherein the remote user interface is configured to generate a map to a location where tree trimming should be performed.

16. The method of claim 10 wherein the remote user interface is configured to redirect a work crew from an existing location to a location where tree trimming should be performed.

17. The method of claim 10 wherein the remote user interface is configured to select a work crew from a plurality of work crews to travel to a location where tree trimming should be performed.

18. The method of claim 10 wherein the remote user interface is configured to direct a work crew to generate vegetation image data and to transmit the vegetation image data to the network vegetation model system.
